(19) United States
(12) Patent Application Publication
(10) Pub. No.: US 2022/0197403 A1
(43) Pub. Date: Jun. 23, 2022

(54) Artificial Reality Spatial Interactions

(71) Applicant: Facebook Technologies, LLC, Menlo Park, CA (US)

(72) Inventors: James Anthony HUGHES, London (GB); Björn WANBO, London (GB); Fábio RESENDE, San Francisco, CA (US); John Nicholas JITKOFF, Seattle, WA (US); Michael James LEBEAU, London (GB); Gabriel MARTZLOFF, San Francisco, CA (US); Jay CHAN, London (GB); Javier Alejandro Sierra SANTOS, London (GB); Jenny KAM, Seattle, WA (US); Yeliz KARADAYI, Seattle, WA (US)

(73) Assignee: Facebook Technologies, LLC, Menlo Park, CA (US)

(21) Appl. No.: 17/691,272

(22) Filed: Mar. 10, 2022

Related U.S. Application Data
(60) Provisional application No. 63/227,601, filed on Jul. 30, 2021.
(60) Provisional application No. 63/221,566, filed on Jul. 14, 2021.
(60) Provisional application No. 63/211,788, filed on Jun. 17, 2021.
(60) Provisional application No. 63/209,365, filed on Jun. 10, 2021.

(51) Int. Cl. G06F 3/038; G06F 3/0354

(52) U.S. Cl. CPC G06F 3/038; G06F 3/03543

(57) ABSTRACT

Aspects of the present disclosure are directed to virtual interaction modes for social and group communication. Additional aspects of the present disclosure are directed to automated controls for connecting a trigger performed in an artificial reality environment to an action on a personal computing device. Further aspects of the present disclosure are directed to providing versions of person virtual objects in an artificial reality environment and contextual breakpoints to switch between them. Yet further aspects of the present disclosure are directed to extending a mouse for artificial reality environment input.

### CROSS REFERENCE TO RELATED APPLICATIONS

This application claims priority to U.S. Provisional Application Nos. 63/209,365 filed Jun, 10, 2021, entitled “Artificial Reality Automated Remote Desktop Actions,” 63/211,788 filed Jun. 17, 2021, entitled “Spatial Virtual Interaction Modes,” 63/221,566 filed Jul. 14, 2021, entitled “People Object Core Interaction Model ,” and 63/227,601 filed Jul. 30, 2021, entitled “Extending a Mouse for Artificial Reality Environment Input.” Each patent application listed above is incorporated herein by reference in their entireties.

### BACKGROUND

Virtual spaces have become a common way of communication between remote users. Voice chats, messaging platforms, and 2D/3D rooms are types of virtual spaces that are used frequently for people to connect with one another remotely. Users can, in some cases, join a “room” of a virtual space to communicate and interact with other users in the room. For example, a user can join a voice call to talk with other users, a video call to see other users in front of their cameras, or a 2D/3D virtual room to interact with the digital avatars of other users.

Artificial reality systems provide an artificial reality (XR) environment, allowing users the ability to experience different worlds, learn in new ways, and make better connections with others. Devices such as head-mounted displays (e.g., smart glasses, VR/AR headsets), projection “cave” systems, or other computing systems can present an artificial reality environment to the user, who can interact with virtual objects in the environment using body gestures and/or controllers. These XR reality systems can track user movements and translate them into interactions with “virtual objects” (i.e., computer-generated object representations appearing in a virtual environment.) For example, an artificial reality system can track a user's hands, translating a grab gesture as picking up a virtual object. While a user is seeing and interacting with virtual objects, the user's physical movements occur in the real world. Some of the objects that a user can also interact with are real (real-world) objects, which exist independently of the computer system controlling the artificial reality environment.

Interaction with computing systems are often founded on a set of core concepts that define how users can interact with that computing system. For example, early operating systems provided textual interfaces to interact with a file directory. This was later built upon with the addition of “windowing” systems whereby levels in the file directory and executing applications were displayed in multiple windows, each allocated a portion of a 2D display that was populated with content selected for that window (e.g., all the files from the same level in the directory, a graphical user interface generated by an application, menus or controls for the operating system, etc.). As computing form factors decreased in size and added integrated hardware capabilities (e.g., cameras, GPS, wireless antennas, etc.) the core concepts again evolved, moving to an “app” focus where each app encapsulated a capability of the computing system.

The introduction of artificial reality systems has provided the opportunity for further interaction model shifts. Existing artificial reality systems provide models, such as 3D virtual objects and 2D panels, with which a user can interact in 3D space. Existing artificial reality systems have generally backed these models by extending the app core computing concept. For example, a user can instantiate these models by activating an app and telling the app to create the model, and using the model as an interface back to the app. Artificial reality systems may have a set of primitives, i.e., objects that can be instantiated by all kinds of applications, have standard interaction models, and visual configurations, and can be passed between applications. However, these need to be well defined before the artificial reality system can be widely adopted.

Artificial reality devices are becoming more prevalent. However, their input mechanisms generally include recognized hand gestures, voice commands, or six-degree-of-freedom (6DoF) position tracked controllers—all of which users find somewhat imprecise as detailed input mechanisms. Meanwhile, a number of precise input mechanisms have been developed for personal computing systems, such as mice, styluses, touch or control pads, etc. However, these have not been adapted for effective use in artificial reality environments.

### SUMMARY

Aspects of the present disclosure are directed to virtual interaction modes for social and group communication. Artificial reality (XR) systems can be difficult for people to become comfortable using. Additionally, XR systems can often be bulky (e.g., heavy and unportable) and cumbersome for people to use for extended periods. Such complications prove difficult for using XR in settings involving connecting and interacting with others in virtual spaces. The virtual interaction modes for group communication can transition people's expectations to be more spatially focused, so that the transition to using XR products is more natural and gradual for users. In some implementations, the virtual interaction modes of group communication can include four different modes, each with a spatial-first design: (1) a spatial audio mode, (2) 2D-rooms mode, (3) video chat mode, and (4) 3D-rooms mode. In each interaction mode, user interactions can have a spatial component, allowing transitions between the modes to feel natural, comfortably immersive, and as if the user is sharing an actual space with other participants.

Aspects of the present disclosure are directed to automated controls for connecting a trigger performed in an artificial reality environment to an action on a personal computing device.

Aspects of the present disclosure are directed to providing versions of person virtual objects in an artificial reality environment and contextual breakpoints to switch between them. In an artificial reality environment, an object control system can represent a person in multiple ways as a virtual “person object,” including: as a glint (which may be paired with controls such as in a conversation widget, in a card, or as a contact), as an avatar, as a portion of an avatar, or as a portrait. The object control system can use a set of contextual breakpoints, such as what application is providing the person object, whether the person object is on a flat vertical or horizontal surface, in midair, or whether the person object is being held by a user, to define which representation of a person object the object control system shows in a given context.

Aspects of the present disclosure are directed to extending a mouse for artificial reality environment input. An XR mouse extension system can interpret context switches to specify whether a user's intent is to use her mouse in relation to her personal computer (PC) or as a virtual cursor interaction tool in the artificial reality environment. Such context switches can include a user indication, such as moving her mouse off the edge of her PC screen, or an explicit command, such as activation a UI control or pressing one or more mouse or keyboard buttons. The XR mouse extension system can operate with various types of artificial reality environments, such as one provided as virtual reality (VR) or as augmented or mixed reality (AR/MR) environment. For example, a user in VR may have a stream of her PC display in the artificial reality environment, and may be able to use her real-world mouse to either provide input to the PC and thus the streamed PC screen, or show a virtual cursor in the virtual reality environment. As another example, a user in MR may see her PC display through the lenses of an MR device and may be able to use her real-world mouse to either provide input, which she sees on her live PC display, or her MR device may create a virtual cursor which it can display over the real-world as a virtual object in the artificial reality environment.

### BRIEF DESCRIPTION OF THE DRAWINGS

FIG. 1 is a conceptual diagram illustrating an example of workroom for connecting users in the virtual interaction modes.

FIG. 2 is a conceptual diagram illustrating an example of spatial audio mode of the virtual interaction modes.

FIG. 3 is a conceptual diagram illustrating an example of 2D-rooms mode of the virtual interaction modes.

FIGS. 4A-B are conceptual diagrams illustrating examples of further 2D modes where some users are participating in the virtual space via a video chat mode.

FIG. 5 is a conceptual diagram illustrating an example of 3D-rooms mode of the virtual interaction modes.

FIGS. 6A-6M illustrate an example of connecting users in spatially oriented virtual interaction modes.

FIG. 7 illustrates an example of an artificial reality environment in which multiple users are collaborating.

FIG. 8 illustrates an example of the artificial reality environment in which a user is importing images from her laptop without leaving the artificial reality environment.

FIG. 9 illustrates an example of the artificial reality environment in which an image has been imported into the artificial reality environment.

FIG. 10 is a flow diagram illustrating a process used in some implementations for triggering, from an artificial reality (XR) device, an action on a personal computing device.

FIG. 11 is an example of a person object as a glint in multiple contexts.

FIG. 12 is an example of a person object as an avatar.

FIG. 13 is an example of a person object as a portrait.

FIGS. 14 and 15 illustrate examples of peeling a person object out of a list as a glint and dropping the glint onto a flat surface as a contextual breakpoint for transitioning to an avatar version of the person object.

FIG. 16 is a flow diagram illustrating a process used in some implementations for switching between versions of person virtual objects in response to contextual breakpoints.

FIG. 17 is an example of a screen-edge PC-to-XR mouse context switch.

FIG. 18 is an example of determining a subject for the creation of a virtual cursor based on a determined user gaze.

FIG. 19 is an example of a virtual cursor created on an object specified by a gaze focus.

FIG. 20 is a flow diagram illustrating a process used in some implementations for extending a mouse for artificial reality environment input.

FIG. 21 is a block diagram illustrating an overview of devices on which some implementations of the disclosed technology can operate.

FIG. 22 is a block diagram illustrating an overview of an environment in which some implementations of the disclosed technology can operate.

### DESCRIPTION

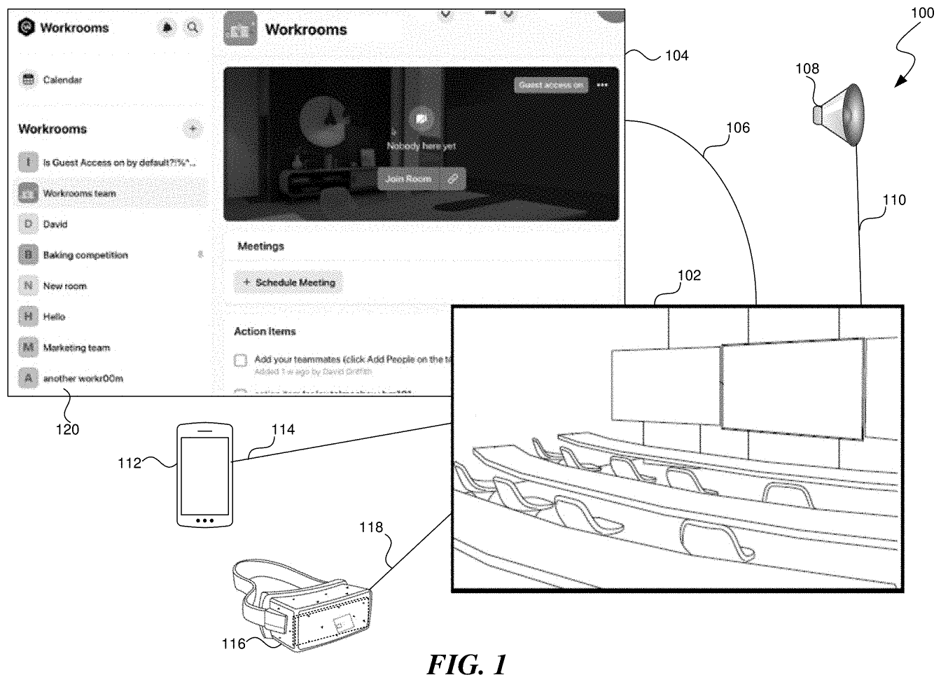

FIG. 1 is a conceptual diagram illustrating an example of workroom 100 for connecting users in the virtual interaction modes. Workroom 100 can include a virtual room 102 defining spatial relationships between users connecting in any of four different spatially-designed virtual interaction modes. Workroom 100 can also include other coordination and access points such as a web interface 104 (using connection 106 to the virtual room 102), a an audio only interface 108 (using connection 110 to the virtual room 102), a mobile device audio or video interface 112 (using connection 114 to the virtual room 102), and an XR device interface 116 (using connection 118 to the virtual room 102). The four different spatially-designed virtual interaction modes can include: (1) spatial audio mode, (2) 2D-rooms mode, (3) video chat mode, and (4) 3D rooms mode. The virtual interaction modes can be interfaces and systems for users to experience group communication in a spatial manner (e.g., as if they were positioned in a room with other users).

A user can join workroom 100 via XR device interface 116, such as by donning an XR headset setup to connect to the workroom 100 (e.g., through a calendar integration, a command to the XR headset from another device, etc.) or by a user providing a command to access the workroom 100 (e.g., by interacting with a GUI element displayed in a virtual environment). A user can join workroom 100 via mobile interface 112, such as by accessing a link, executing a linked app, or using a dial-in number. A user can join workroom 100 via web interface 104, such as by accessing a link or other webpage assigned to a workroom (e.g., through a list 120 of a user's workrooms). A user can join workroom 100 via audio interface 108, such as by using an audio only device once connected using mobile interface 112 or web interface 104, or by dialing into the workroom 100 with another audio-only device. By allowing users to join through different modes, the virtual space 102 of workroom 100 becomes a combined virtual space where users in different interaction modes can experience different user interfaces while maintaining the spatial relationships of the virtual space 102.

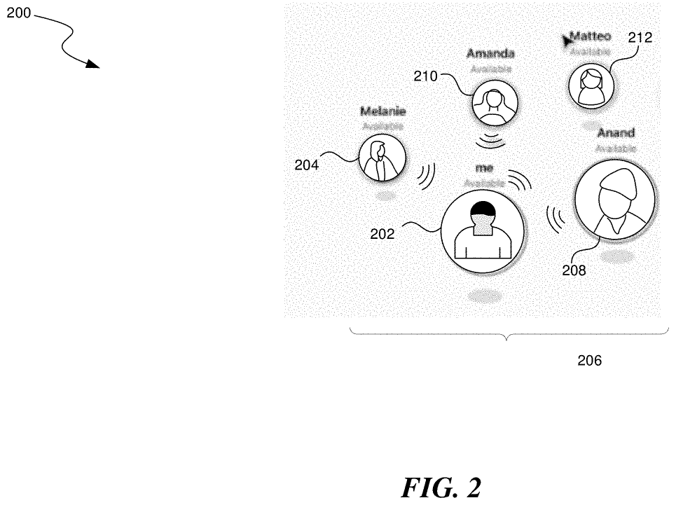

How each user experiences the virtual space 102 can depend on different hardware and software configurations of the computing environment of that user, thus triggering the different interaction modes. More details on the hardware and software configurations that trigger the various modes are described below in relation to FIGS. 2-5. Users can transition or switch between interaction modes by switching between the different the hardware and software configurations. The spatial continuity between the modes can make the transitions feel easy and natural, rather than an immediate jump from a mode with less immersion/fidelity (e.g., a non-spatial audio connection to a discussion) to a mode with great immersion/fidelity (e.g., a 3D room).

Users in workroom 100 can experience the same auditory or visual changes, except represented differently depending on which interaction mode the user is in and how they are spatially positioned in the virtual room 102 (e.g., which part of the room they are spatially anchored to). While in workroom 100, users can share audio, share video, upload files (e.g., notes, documents, photos/videos, links), add action items, connect online accounts, switch to other workrooms, send messages to other users, etc. The spatial experiences in workroom 100 can feel consistent to the users, despite the users being in different hardware and software configurations.

FIG. 2 is a conceptual diagram illustrating an example of spatial audio mode 200 of the virtual interaction modes. Spatial audio mode 200 can trigger when the user has headphones on in workroom 100. As shown in FIG. 2, users 206 have all joined the workroom 100. The indicators for users 206 represent the virtual positions of the users, even though users joining by audio only will not have visual indicators of these positions. When the user joins workroom 100 via spatial audio mode 200, spatial audio mode 200 can position or anchor the user spatially in the virtual space 102 of workroom 100. Accordingly, when users in workroom 100 speak, the audio/voices of the users are transmitted to one another based on the virtual position of the users relative to one another. In other words, users in spatial audio mode 200 can hear others as if they are physically around one another, hence experiencing audio spatially. For example, during conversations, “me” 202 can hear “Melanie” 204 close to the left, “Anand” 208 close to the right, “Matteo” 212 far to the right and in front, and “Amanda” 210 directly in front. As another example, when “me” 202 speaks, “Anand” 208 can hear “me” 202 speaking to the very left. Users further can have lesser volume (e.g., when “me” 202 speaks, the voice sounds quitter to “Matteo” 212 than to “Amanda” 210).

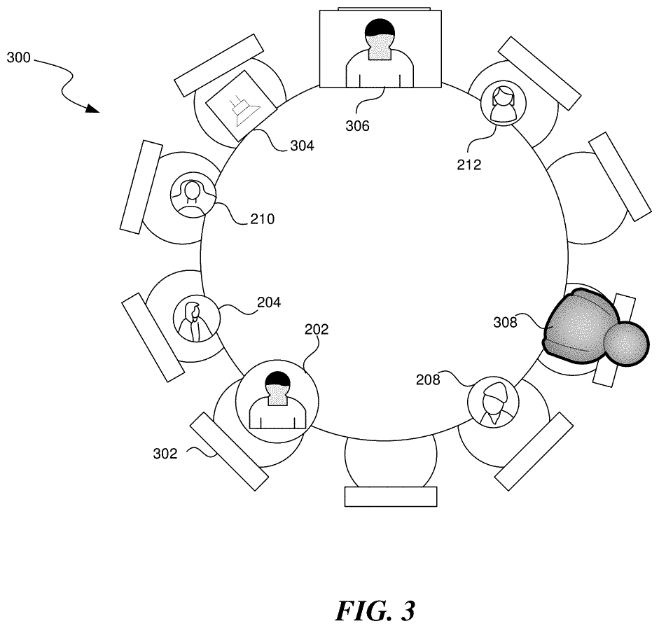

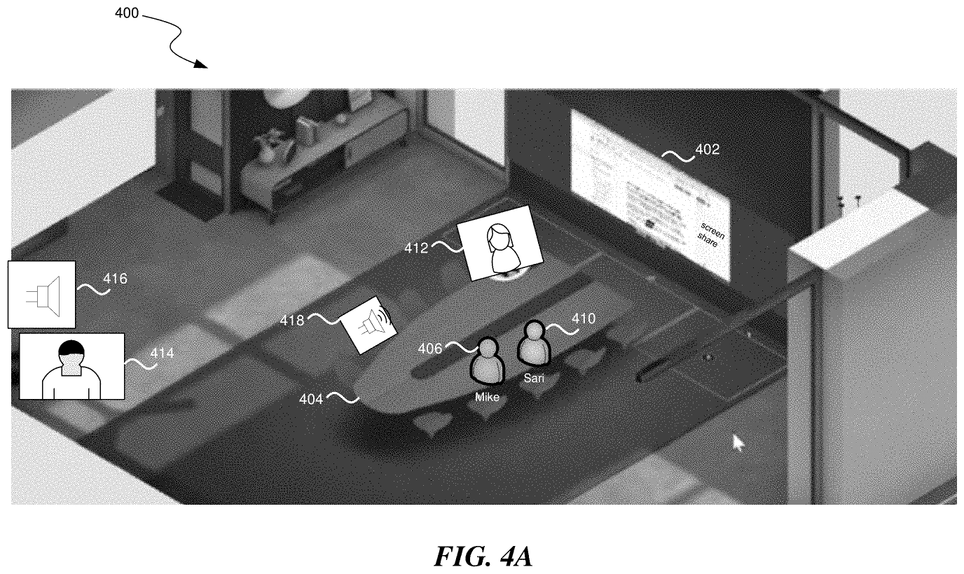

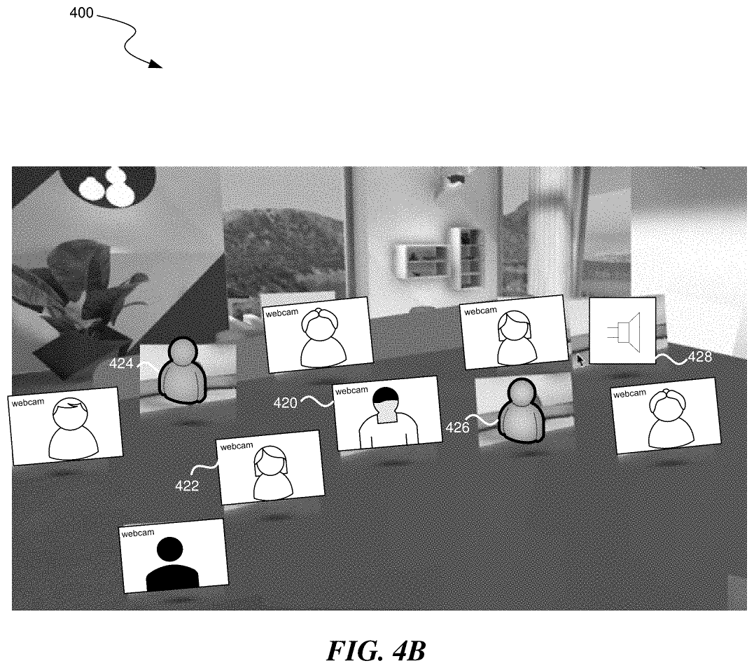

FIG. 3 is a conceptual diagram illustrating an example of 2D-rooms mode 300 of the virtual interaction modes. 2D-rooms mode 300 can trigger and/or transition from another mode when the user has connected to workroom 100 with a device having a computer screen to see a digital representation of the virtual space 102 of workroom 100. For example, workroom 100 can transition from spatial audio mode 200 to 2D-rooms mode 300, or start in the 2D-rooms mode 300, when the user has turned on their computer screen and selected the option to join workroom 100 via 2D-rooms mode. When the user joins workroom 100 via 2D-rooms mode 300, 2D-rooms mode 300 can cause virtual space 102 to be presented to the user as a third person view, such as a top-down view of the virtual room (e.g., a top down auditorium or meeting room with seats) or perspective view (see e.g., FIG. 4A). Upon initially entering the virtual space, a user can select a position, e.g., by selecting chair 302. Accordingly, the user can spatially see the positions of other users 204, 208, 210, and 212 in workroom 100 as they take their own seats and experience the spatial layout of workroom 100. In some implementations, 2D-rooms mode 300 can present various virtual seats and enable the user to select different seats to “sit” in, or in other words, position themselves virtually in workroom 100. For example, when the user of “me” is seated in seat 302, the user can see from his top-down view that “Melanie” 204 is seated close to the left, “Anand” 208 is seated close to the right”, “Matteo” 212 is seated farther to the right and in front, and “Amanda” 210 is seated farther to the left and in front. As the users speak, the audio continues to be spatially oriented according to these positions (as discussed in relation to FIG. 2).

In some implementations, as users join using other modes, the manner those users are displayed in the top-down view can reflect their mode. For example, a user who joined using an audio only mode can be shown with an audio icon 304 while a user who joined via video call can be shown with their video feed 306. In some implementations, users who have joined through a VR mode can be shown with an avatar 308, which may be animated to show movement of the user controlling the avatar.

In some implementations, 2D-rooms mode 300 can present the user the option to cluster with different groups of users in workroom 100 to chat with. For example, a user can drag his/her chat icon to different seats in the virtual room or create free-from clusters with users away from the table.

FIGS. 4A-B are conceptual diagrams illustrating examples of further 2D modes where some users are participating in the virtual space 102 via a video chat mode. The video chat mode can trigger and/or transition from another mode when the user has a computer screen and video camera on in workroom 100. For example, workroom 100 can transition from the top-down 2D-rooms mode to video chat mode, or start in the 2D-rooms mode to video chat mode, when the user turns on their video camera (e.g., webcam). When the user joins workroom 100 via the video chat mode, the virtual space 102 of workroom 100 can be presented to the user as a spatial layout with video calling windows (e.g., video camera or webcam feed of user) of other users also in video chat mode, call icons of other users in spatial-audio mode or 2D-rooms mode, or virtual avatars of other users in 3D-rooms mode. The video chat mode can cause the user him/herself to be presented in workroom 100 as a video calling window to other users. For example, in FIG. 4A, video calling window 412 can represent the user in video chat mode. Video calling window 412 can be a video camera feed of the user. Further, the video connection of the user can be a presentation of the virtual space 102 from the perspective of the user's position. For example, the user controlling video feed 412 would see the video from a virtual camera positioned at video feed 412 into the virtual space. Avatar 406 and avatar 410 can represent users in 3D-rooms mode, video calling windows 412 and 414 can represent users in video chat mode, and audio icons 416 and 418 can represent a user in spatial audio mode or 2D-rooms mode. Users in various modes may also be able to share contents on his/her computer screen (in presentation area 402) for presenting to the other users in workroom 100.

In FIG. 4A, video chat mode 400 can cause workroom 100 to be presented as a virtual room with table virtual object 404 and seat virtual objects. When the user joins via video chat mode 400, workroom 100 can position or anchor the user in workroom 100, such as by placing the user at one of seats around table 404. Some users, including those of avatars 406 and 410, and video calling window 412, can be clustered at the table 404. By positioning users around the table in different interaction modes, workroom 100 can allow users in different modes to communicate and interact with one-another with different degrees of immersion or fidelity. Furthermore, users can share content at the table, such as sharing their screen in video calling window 402 or dragging files onto the table to share the files.

Users can form clusters away from the table, such with users 416 and 414. Users can continue to speak and hear one another spatially. For example, the user controlling video feed 412 may not be able to see the video feed 414, but may still hear spatial audio from this video feed if it is loud enough (and configured to be heard outside the separate cluster of 416 and 414). Users 416 and 414 can speak and hear one another spatially, while hearing the users around table 404 faintly or not at all.

In some implementations, the video chat mode can allow the user controlling their video feed to pan around their point of view into virtual space 102. For example, the video chat mode can enable the user controlling video feed 412 to pan right using (e.g., using a right arrow key) to the cluster of users 416 and 414. In some implementations, the video chat mode can allow a user to move around the virtual space 102. For example, the video chat mode can allow video calling window 412 be moved to another seat or away from table 404 to the corner with the cluster of 416 and 414.

In FIG. 4B, video chat mode 400 can cause workroom 100 to be presented to the user as a virtual room with various video calling windows (e.g., video calling windows 420 and 422) of users in video chat mode, as avatars of users in 3D-rooms mode (e.g., avatars 424 and 426), or as audio-only participants (e.g., audio icon 428). A user in video chat mode may see these users from a perspective of a virtual camera place where their video chat feed is in the room. A user in video chat mode may be able to pan around to see other the video calling windows of other users and change the direction of their spatial audio when speaking with one another.

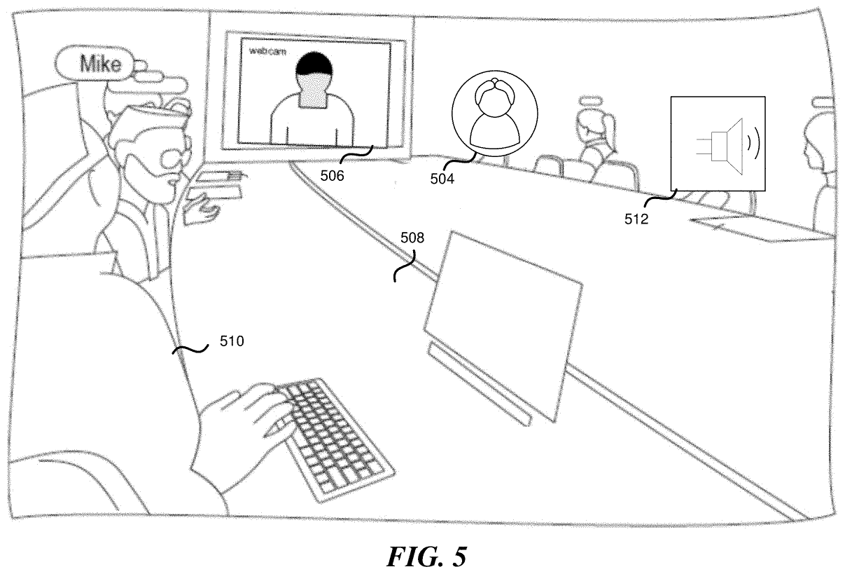

FIG. 5 is a conceptual diagram illustrating an example of 3D-rooms mode 500 of the virtual interaction modes. 3D-rooms mode 500 can trigger and/or transition from another mode, or start in the 3D-rooms mode, when the user puts on an XR headset. For example, workroom 100 can transition from 2D or video chat mode to 3D-rooms mode when the user has put on an XR headset. When the user joins workroom 100 via 3D-rooms mode 500, 3D-rooms mode 500 can cause workroom 100 to be presented to the user as a virtual or augmented reality environment with three or six degrees of freedom. 3D-rooms mode 500 can cause the user him/herself to be presented in workroom 100 as an avatar (avatar body unshown since FIG. 5 is from the perspective of the user him/herself, but other avatars such as avatar 510 is shown). Such avatars can have various levels of fidelity to the actual user, from a fully animated fanciful avatar to a hologram view depicting a real-life and live view of the user. 3D-rooms mode 500 can cause workroom 100 to present users in 3D-rooms mode as avatars (e.g., avatar 510), users in video calling mode as video feeds (e.g., video feed 506), or users in 2D-rooms or spatial-audio mode as call icons (e.g., icons 504 and 512). 3D-rooms mode 500 can maintain the spatial audio from the other modes, even as the user moves around the room. Workroom 100 can allow the various users seated at virtual table 508 to communicate and interact with one-another with different degrees of immersion or fidelity depending on the virtual interaction modes they are in.

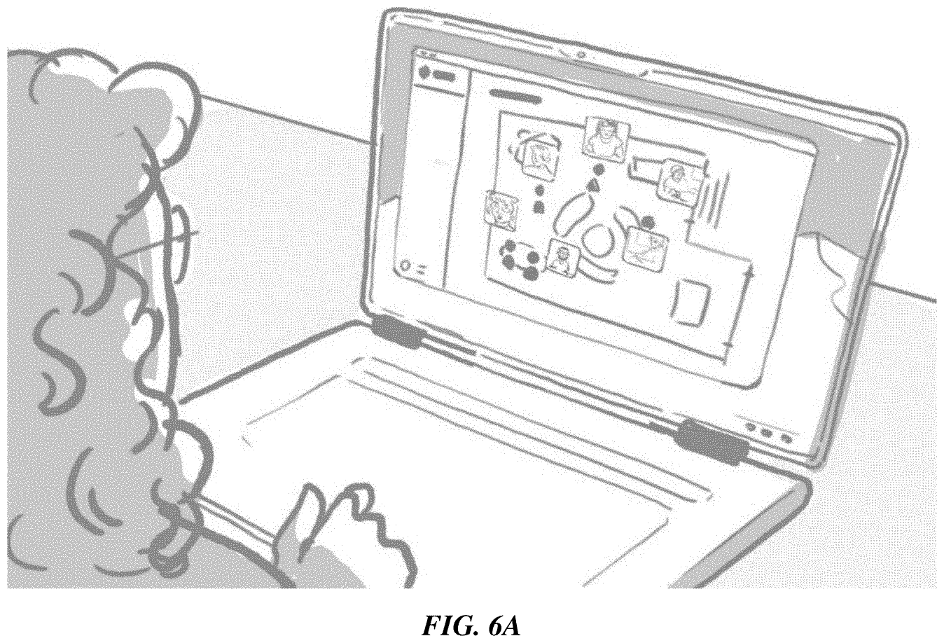

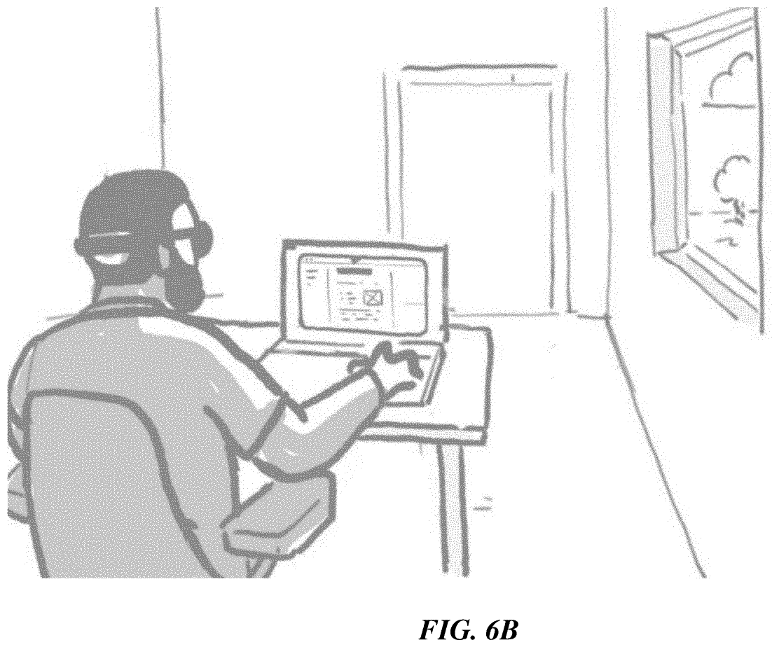

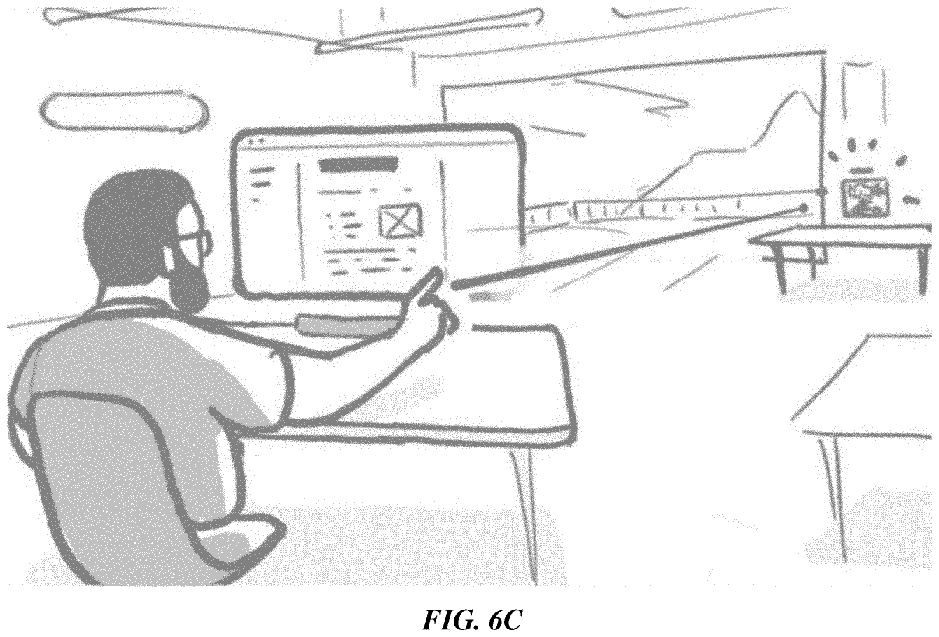

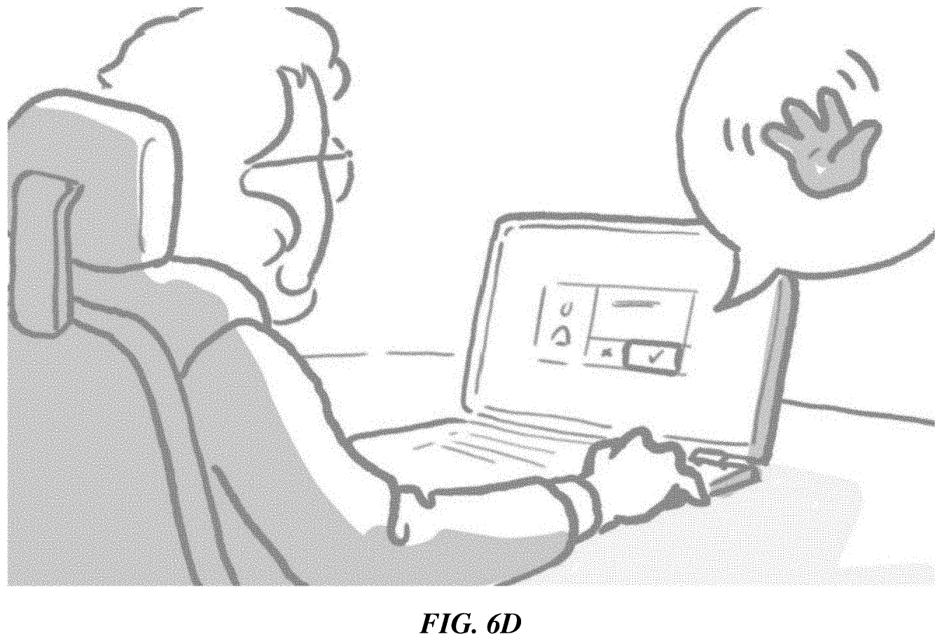

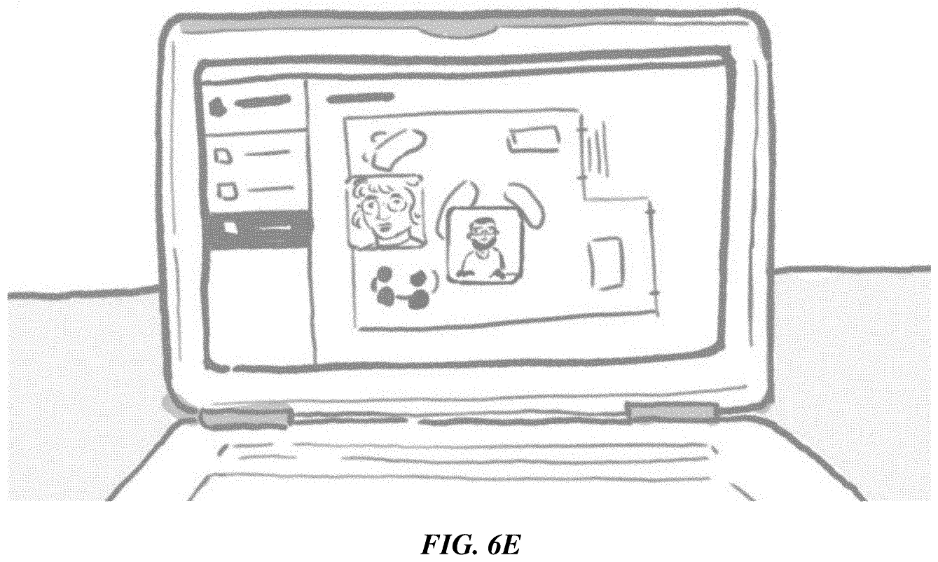

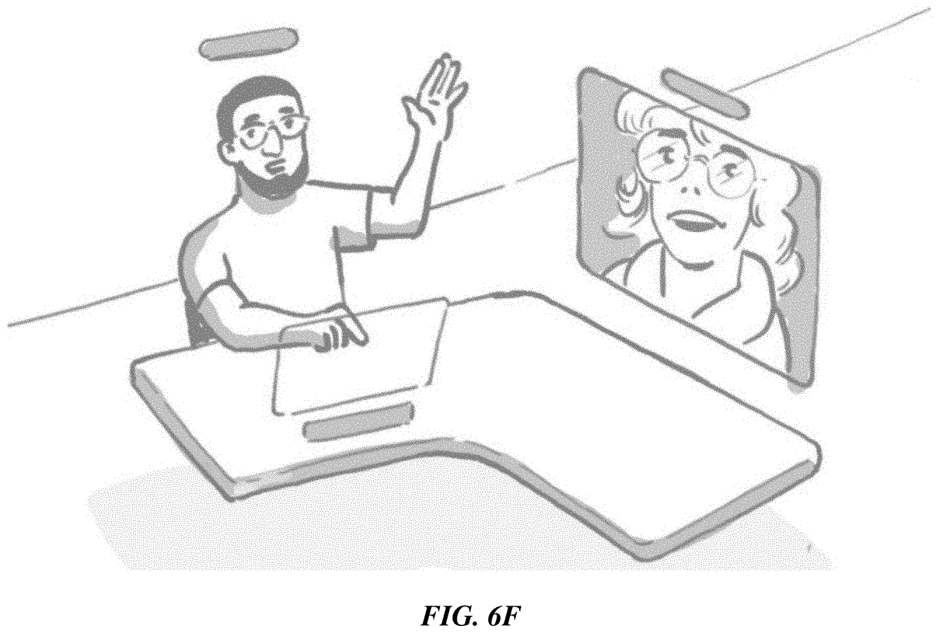

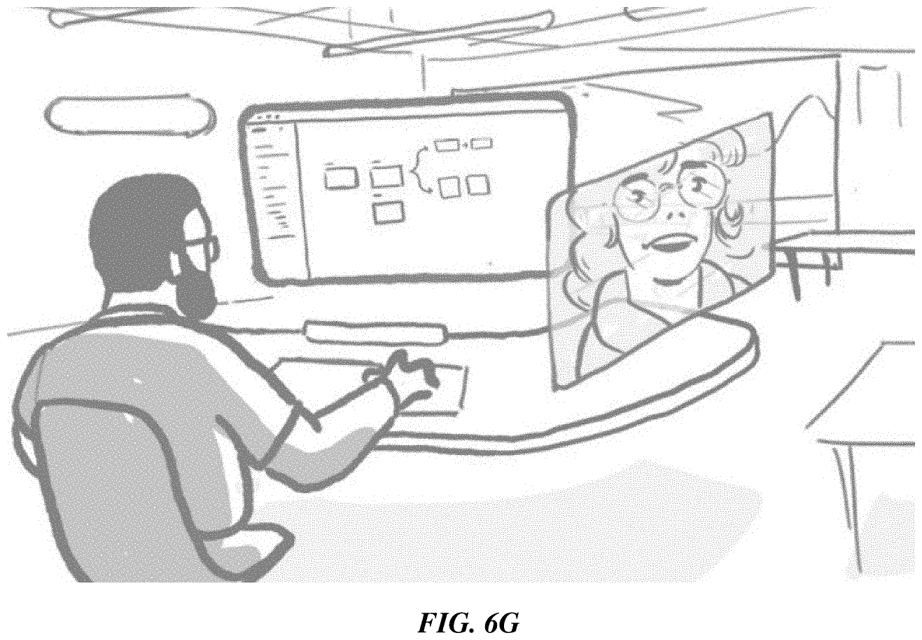

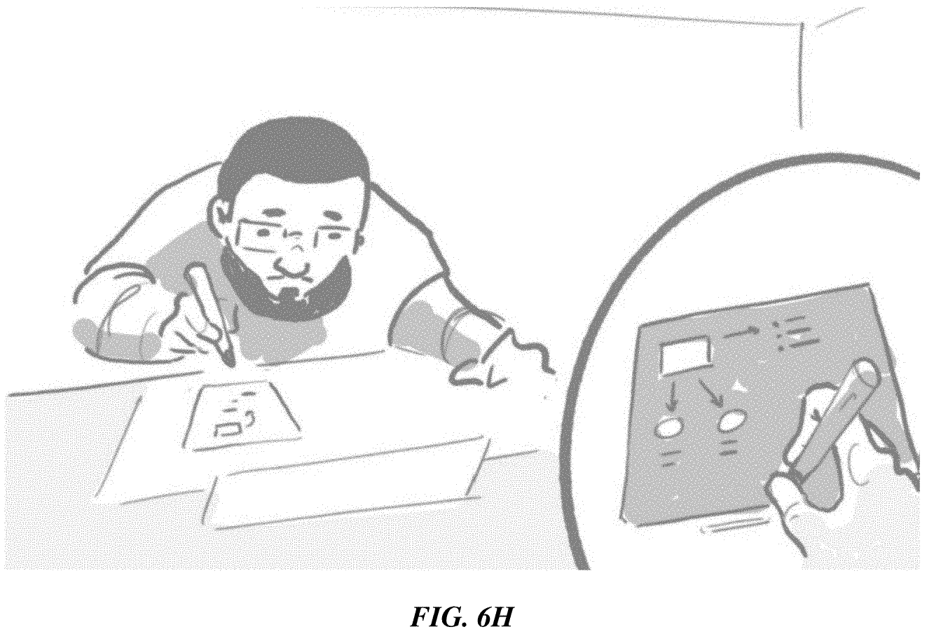

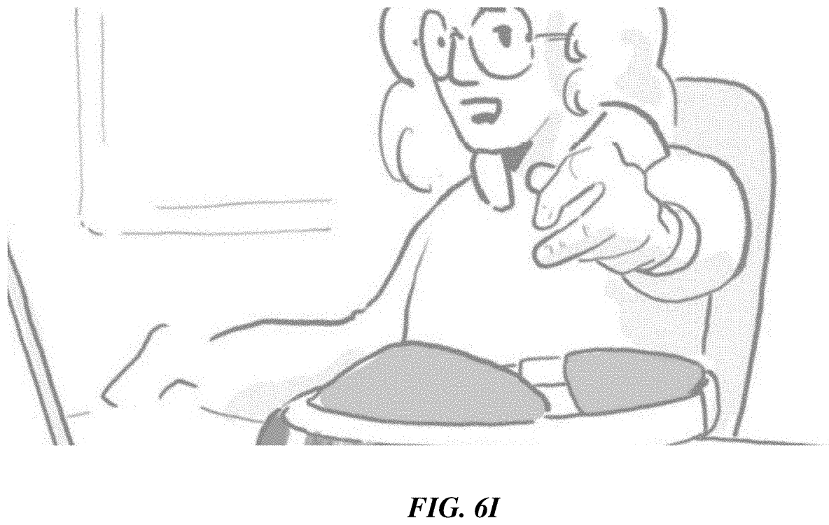

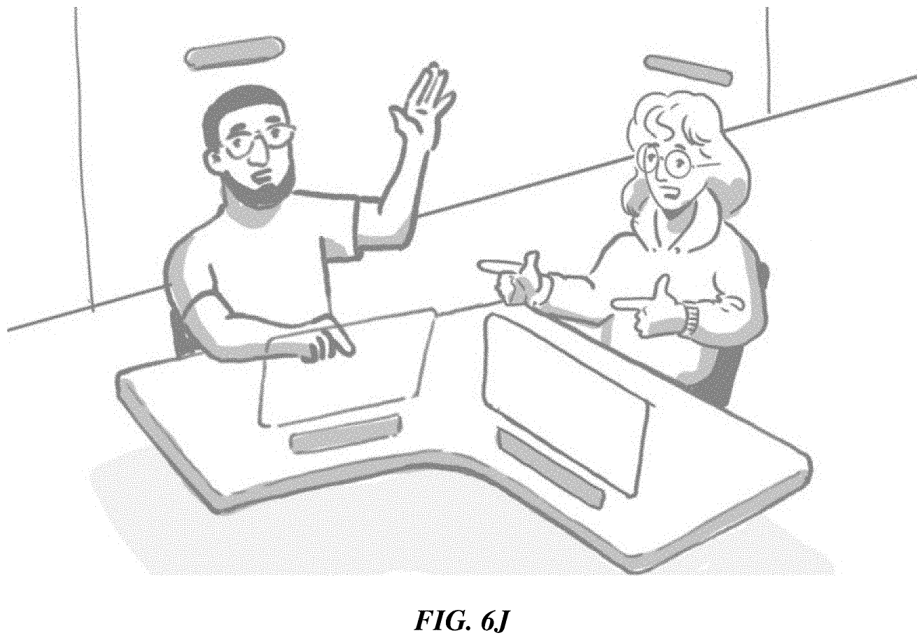

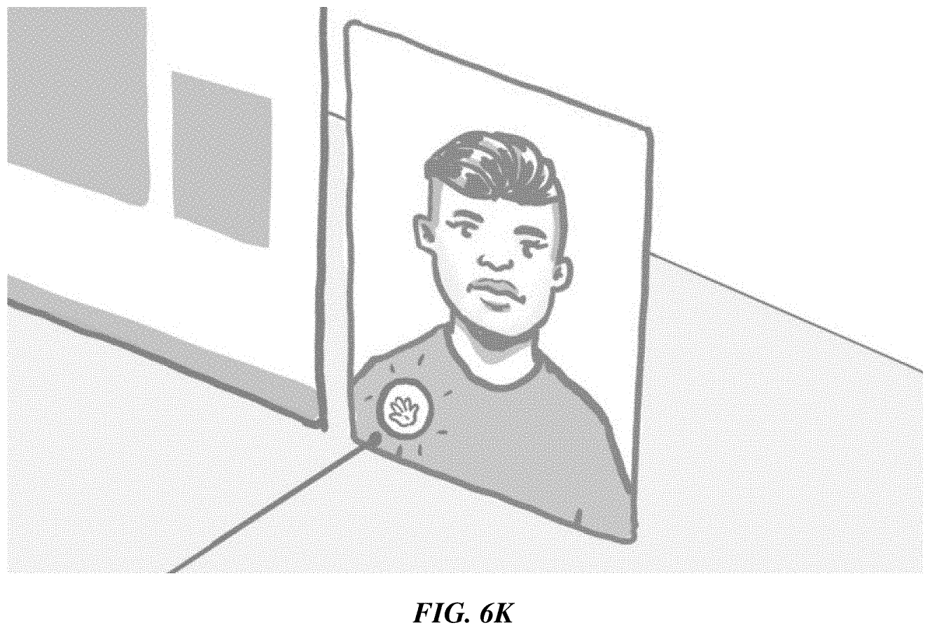

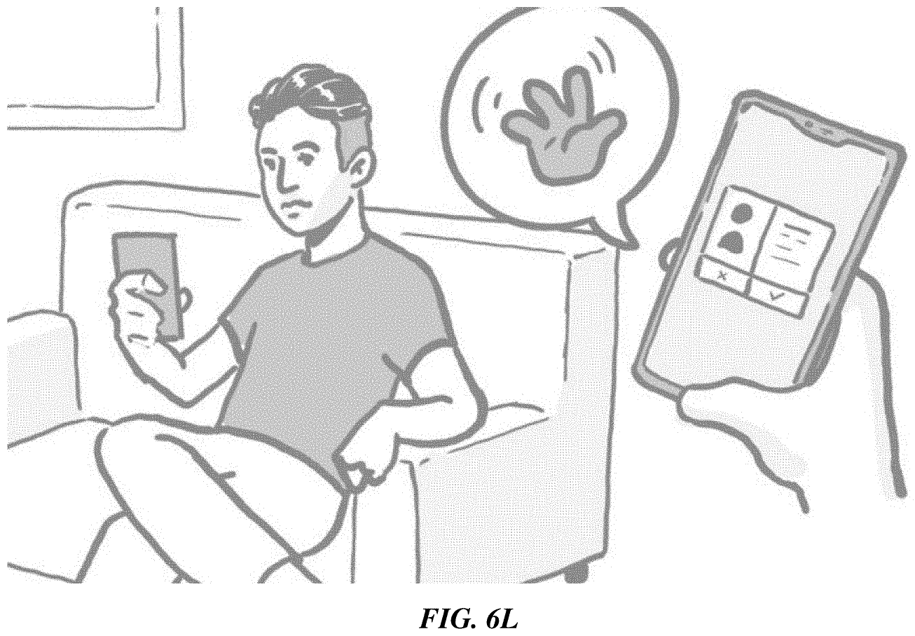

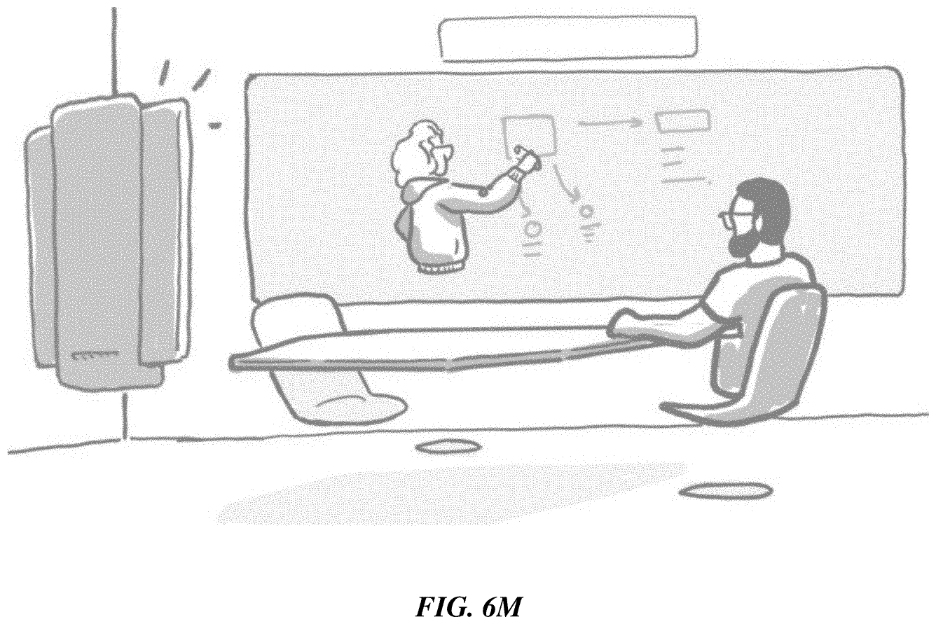

The following example, corresponding to FIGS. 6A-6M, illustrates an example of connecting users in spatially oriented virtual interaction modes. Every morning, like most of her colleagues, Sally joins her workroom (via a web interface) from her laptop for some casual discussions and a pretty informal stand-up to kick off the day. Some of the team leave after that but a few stay around so they can work with their colleagues in the background to feel more connected and stay in the work mindset throughout the day. In the workroom page, Sally can see all connected members in a spatial view, regardless of what platform they're joining from. That includes Evan who's currently in VR. (See FIG. 6A.) Evan has taken the habit of joining the workroom in VR. Working from the spacious VR workroom is a welcomed break from his small home office. Thanks to the remote desktop he can be just as productive. He also benefits from additional screen estate in VR. (See FIG. 6B.) A little while after standup, Evan and Sally are working independently. Evan has a question regarding a design that was recently submitted, he virtually waives at Sally (who is on web) to discuss. (See FIG. 6C.) Sally accepts and they start an active conversation. (See FIG. 6D.) Evan and Sally now appear in the same “cluster” on the room view. (See FIGS. 6E and 6F.) As they're discussing, Sally starts sharing her desktop which appears at a comfortable angle for both of them to look at. They start reviewing a design together. (See FIG. 6G.) To explain how the implementation is currently done, Evan grabs his tracked stylus and scribbles a rough diagram on his virtual scribing tool. (See FIG. 6H.) Sally clicks the “Continue in VR” button, which wakes up her VR device. Sally puts her VR headset on whilst speaking with Evan over VC still. The workrooms app is already loading and will take her directly to the right room and desk without additional input. (See FIG. 6I.) As soon as she lands in the room the web client automatically ends the VC discussion—Evan sees her Avatar materialize in front of him, the screenshare remains connected. (See FIG. 6J.) As the discussion continues, they realize they need Marta's input who implemented the feature originally. Marta is not currently present in the workroom but Evan can send her an invite to join the discussion. (See FIG. 6K.) Marta receives a chat message with a link to join via VC or one to join in VR. She chooses to join via VC. (See FIG. 6L.) Now that this discussion is involving more people, they decide to promote it so everyone is in the same 3D VR workroom by the click of a button. (See FIG. 6M.) After the discussion ends, Sally takes off her headset and her web client prompts an interstitial asking if she wants to re-join the workroom on the web.

When working in an artificial reality environment, especially fully immersive ones such as those provided by virtual reality systems, users can find it troublesome to switch between interactions with the XR device and other personal computing devices (e.g., laptop, desktop, mobile phone, etc.) For example, a user may want to access files on her laptop while in a VR meeting or send an image from her phone to her mixed reality headset. However, such actions can require the user to remove the XR device to be able to access controls for the personal computing device and/or perform a complicated series of actions on the personal computing device to send the relevant information to the XR device.

A cross-surface intent system disclosed herein allows triggers recognized by the XR device, such as gestures, activating UI controls, spoken commands, entering a given space, etc., to cause an action on another device linked to the XR device. The cross-surface intent system can include a set of mappings of XR triggers to personal computing device actions. In various implementations, the mappings can be user customizable, context-specific, and/or parameter driven. For example, a user may be able to set new mappings, define rules for how action should occur when the XR device or personal computing device recognizes various contexts, or provide variations for an action depending on parameters passed to it when the corresponding trigger is activated. In various implementations, the actions on the personal computing device can include, for example, opening a web browser to a particular website, making an API call, executing a given script or application, performing a series of UI inputs, sending a message or sharing content with a given recipient (e.g., participants of a current shared artificial reality environment), etc.

Some artificial reality (XR) systems allow users to interact with their personal computing devices though a “remote desktop,” providing the ability for the user to interact with the personal computing device while in the artificial reality environment provided by an XR system. In some implementations, one or more of the mappings of the cross-surface intent system can include a trigger mapped to initiating a remote desktop connection with a personal computing device, which can bring up the personal computing device's display in the artificial reality environment. This allows the user to interact with the personal computing device without having to take off her XR device or interact with controls of the personal computing device. In some cases, the trigger can further be mapped to automated actions on the personal computing device such that when the remote desktop connection is initiated, workflows, content items, social interactions, etc. are queued up, allowing the user to easily perform relevant actions.

For example, a first UI button in the artificial reality environment can be a trigger for an image import flow on the personal computing device, such that activating the first UI button causes the remote desktop to be displayed and the personal computing device to open a web portal for uploading images from the personal computing device to a shared whiteboard in the artificial reality environment. In this example, with a single virtual button click while a user is in a VR collaboration, she can access an interface to select images or other content saved on her laptop and share it with the collaboration participants. As another example, a second UI button in the artificial reality environment can be a trigger for an participant invite flow on the personal computing device, such that activating the second UI button causes the remote desktop to be displayed and the personal computing device to make an API call to a calendar application, opening an invitation widget pre-loaded with invite information for the VR collaboration in which the user is participating. In this example, with a single virtual button click while in the VR collaboration, the user can reach an interface to ask other users to join her in the VR collaboration.

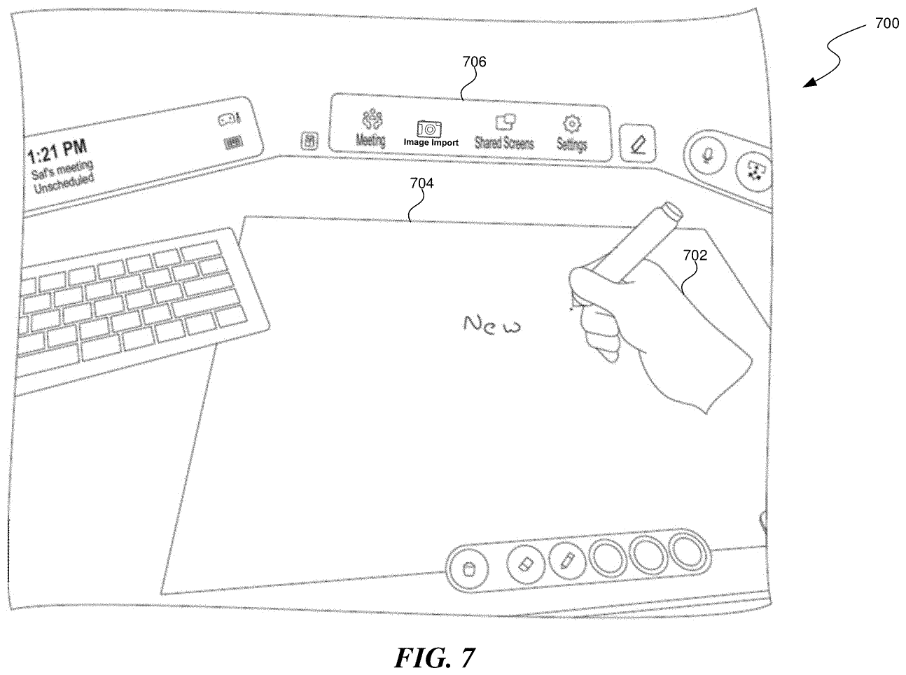

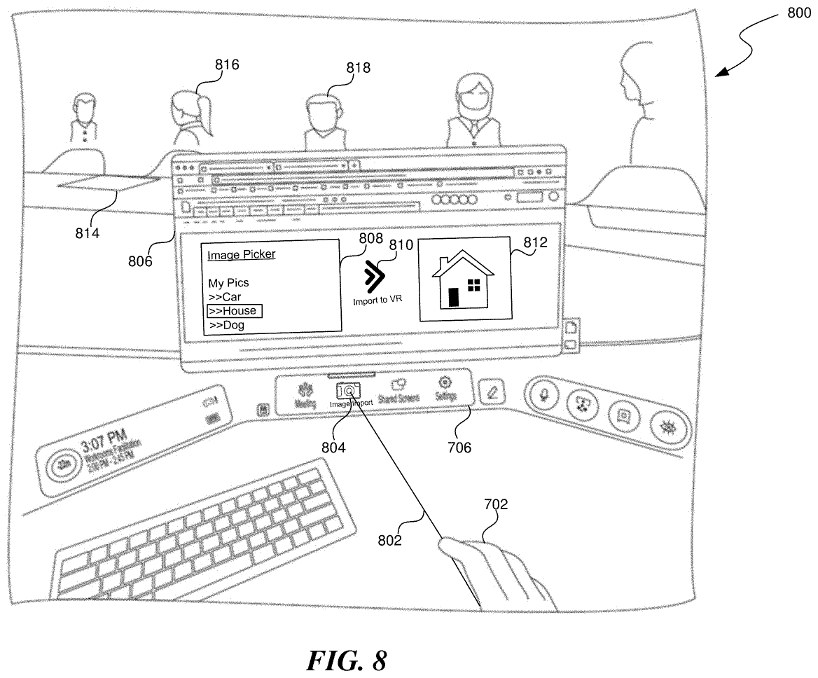

FIG. 7 illustrates an example 700 of an artificial reality environment in which multiple users are collaborating. In example 700, a user 702 is working on a shared workspace 704, which is mirrored to a shared whiteboard (not shown) and other workspaces (such as workspace 814 in FIG. 8) that multiple other users (such as users 816 and 818 in FIG. 8) in the collaboration can view. The user 702 has access to various controls, such as controls 706, allowing the user to take actions such as setting up screen sharing, performing an image import, accessing settings, etc.

FIG. 8 illustrates an example 800, continuing example 700, of the artificial reality environment in which a user is importing images from her laptop without leaving the artificial reality environment. In example 800, the user 702 has made a gesture causing a ray 802 to be cast from her hand, which she directs at controls 706. The user 702 uses the ray 802 to select the image import button 804. Image import button 804 is mapped to an action to: initiate a remote desktop with the user 702's laptop, open a web browser on the laptop, and direct the web browser to an image import widget that can load images from the user 702's laptop into the artificial reality environment. Activating button 804 causes the XR device controlling the artificial reality environment to connect to an action service on the user 702's laptop and begin remote desktop session 806 which is showing the image import widget, including an image picker 808 and a control 810 to import a selected image (in this example house image 812) into the artificial reality environment.

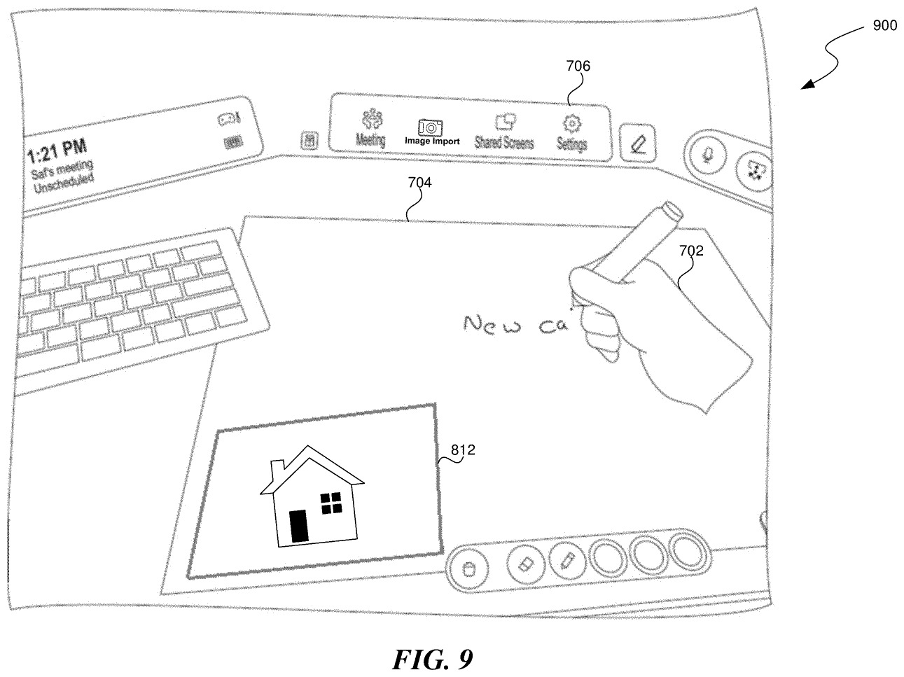

FIG. 9 illustrates an example 900, continuing examples 700 and 800, of the artificial reality environment in which an image has been imported into the artificial reality environment. In example 900, image 812 has been automatically added to the workspace 704, from the user 702's laptop as a result of the image import workflow performed through the remote desktop.

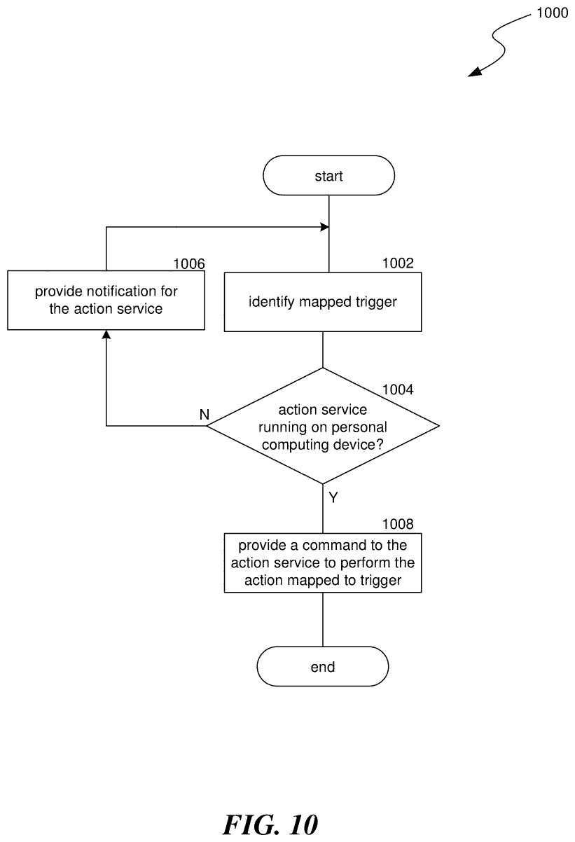

FIG. 10 is a flow diagram illustrating a process 1000 used in some implementations for triggering, from an artificial reality (XR) device, an action on a personal computing device. In some implementations, process 1000 can be performed in response to the XR device being initiated or entering a particular mode, such as when a user loads a program with mappings of triggers to personal computing device actions.

At block 1002, process 1000 can identify a trigger mapped to a personal computing device action. The trigger can be any event or sequence of events recognizable by the XR device (e.g., via cameras, microphones, input devices, etc.) such as a user making a gesture, pointing with a controller, performing a voice command, interacting with a UI element, entering a specified artificial reality environment volume, etc. The action mapped to such a trigger can include any action that can be caused on a personal computing device by a service action, such as making an API call, staring an application, directing an application to perform an action (such as directing a browser to open a given URL), sending a request for an action to the personal computing device operating system, emulating a sequence of user inputs, etc. In some implementations, different triggers can be mapped to actions on different personal computing devices. For example, a spoken command can trigger an action to access a URL via a user's mobile phone while pressing a virtual button can trigger an action to start a remote desktop connection with the user's laptop.

At block 1004, process 1000 can attempt to connect to an action service application of the personal computing device for the action mapped to the trigger identified at block 1002. This connection can be established with predefined connection parameters, such as using an IP address of the personal computing device or by virtue of a user identifier for the current user being mapped by a service provider to application identifiers for given devices. In various cases, the connection can be a direct network connection, a connection via a third party (e.g., vis a server of a platform), or by a location connection such as a local area network, a Bluetooth connection, etc. If the connection to the action service is made, process 1000 can continue to block 1004; otherwise process 1000 can continue to block 1006.

At block 1006, process 1000 can provide a notification in relation to the action service, such as that a connection to the personal computing device for the action is not available, a suggestion to execute the action service on the personal computing device, that the action service cannot perform the indicated action at this time, etc.

At block 1008, process 1000 can provide a command to the action service to perform the action mapped to the trigger identified at block 1002. For example, the action service can be configured with a set of actions, one of which can be indicated by process 1000 for the action service to carry out. As another example, process 1000 can provide a script or other set of operations for the action service to carry out. In various implementations, the action service can perform the action by, e.g., making an API call, executing a set of instructions, staring an application, directing an application to perform an action, sending a request for the action to the personal computing device operating system, emulating a sequence of user inputs, etc.

For example, the action can be to setup a remote desktop connection with the XR device. The application service can instruct the personal computing device operating system to connect to another monitor driver provided for the remote desktop connection. The personal computing device can then provide video output through that driver to display the video output in the artificial reality environment.

An object control system can represent people as virtual objects (i.e., “people objects”) in an artificial reality environment. In various implementations, the object control system can illustrate a person object in different views including a glint view, an avatar view, and a portrait view. In a given view, the person object can include a realistic representation of the person (e.g., a photo, 3D model, hologram, live feed, etc. of the user) or a representation of an avatar of the user (e.g., an avatar with features that match the user or a fanciful character selected to represent the user). The object control system can use various contextual factors (i.e., “contextual breakpoints”) to select which view of a person object to use at a given time. In some implementations, the permissions of the viewing user can further determine which version of a person object the object control system shows, e.g., the various levels of fidelity from an avatar based view up to the live feed view can have different permissions, and the object control system can show the highest level of fidelity to the represented person that the viewing user has permissions to see.

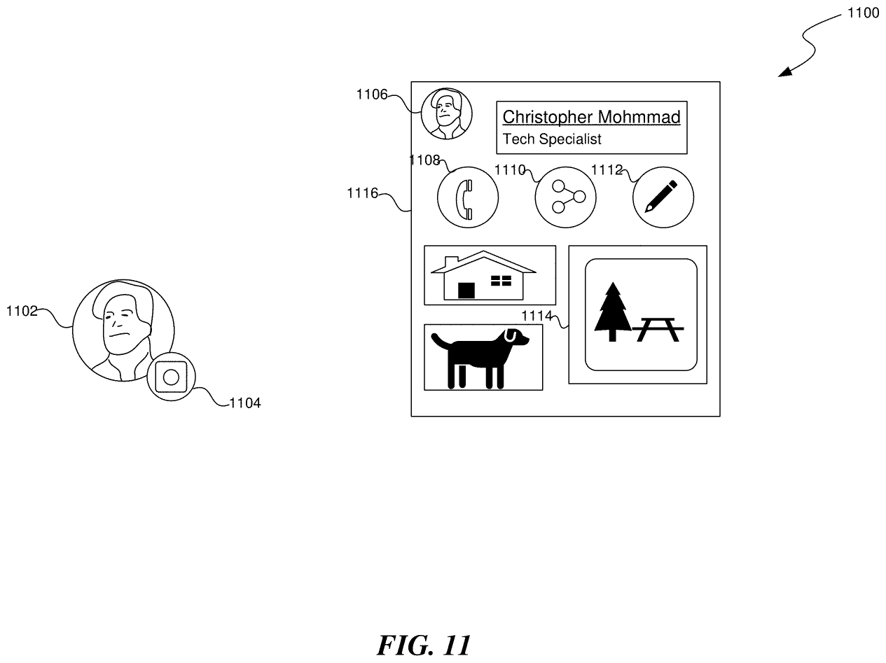

A glint view of a person object can show the person object reduced to an icon of a maximum size—e.g., shown as an icon of the user's image, an icon of the user's avatar, or an icon using a generic image for all users (e.g., a user silhouette). In various cases, the object control system can display the glint view when the user object is being manipulated by the viewing user (e.g., being held) or when the person object is embedded in another object such as a list of users, a contact card with other controls, or in other contexts where space is limited or a simple user representation facilitates manipulation of the person object. FIG. 11 is an example 1100 of a person object as a glint in multiple contexts. Example 1100 includes an example glint view 1102 of a person object showing an icon version of a picture of the represented user and an icon 1104 representing a source application of the user image. Example 1100 also include an example of the glint view 1106 of the person object embedded in a contact card 1116. The contact card 1116 includes the glint view 1106, with associated contact information, control 1108 for calling the represented person, control 1110 for sharing the contact card 1116, control 1112 for editing the contact card, and pictures, such as picture 1114, recently posted to social media by the represented person.

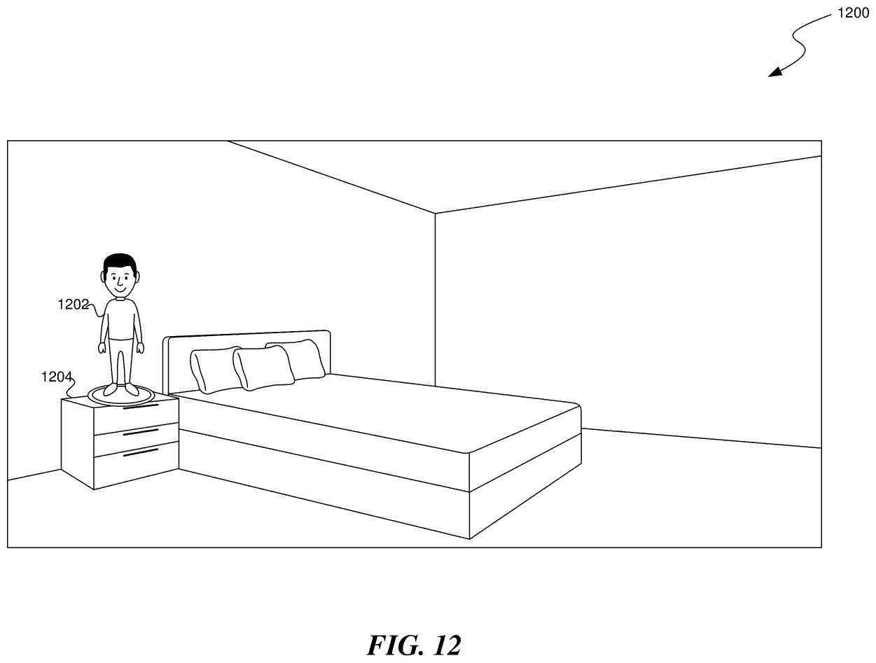

An avatar view of a person object can show the person object as a 3D model standing on a surface or hovering in the air. In various implementations, the represented user can select her avatar e.g., from a set of predefined avatars or by selecting avatar features to build a custom avatar. In some cases, the avatar features can match the represented user while in other cases the avatar features can be completely different from the real-world user, even portraying the user as a creature, alien, or other fanciful display of the user's choosing. In various cases, the object control system can display the avatar view when the person object is placed on a flat horizontal surface. FIG. 12 is an example 1200 of a person object as an avatar. Example 1200 includes avatar 1202 person object, which has been set as an avatar due to having been placed on the flat horizontal surface 1204 of the viewing user's bedside table.

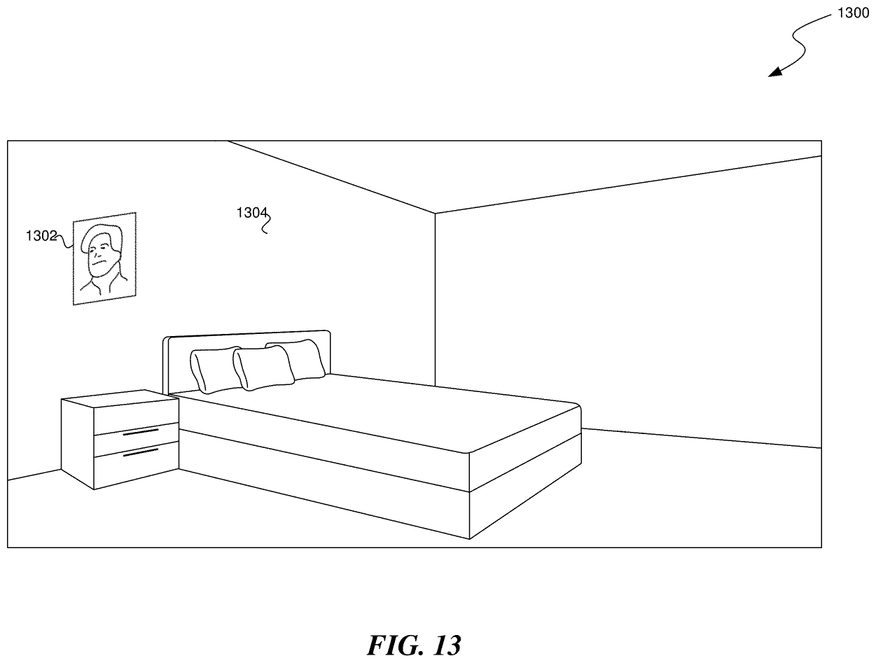

A portrait view of a person object can show the person object as a flat panel on a surface—e.g., shown as the user's image, an image of the user's avatar, or a generic image for all users (e.g., a user silhouette). In various cases, the object control system can display the portrait view when the user object has been placed on a flat, vertical surface. In some implementations, a portrait view can show an infinite depth environment set behind an avatar and/or the avatar in the portrait can be animated. For example, when the portrait has an infinite depth environment, different parts of the environment can be seen when the portrait is viewed from different angles. The avatar animations can include animations matching context of the avatar or that match an indicated expression or mood of the user represented by the avatar. In some cases, animations can be subject to the viewing user's device modes (e.g., do not disturb) or the user's manual control (e.g. user puts their avatars on quiet mode) so animations don't play and notifications don't come through. FIG. 13 is an example 1300 of a person object as a portrait. Example 1300 includes portrait 1302 person object, which has been set as a portrait due to having been placed on the flat, vertical surface 1304 of the viewing user's wall.

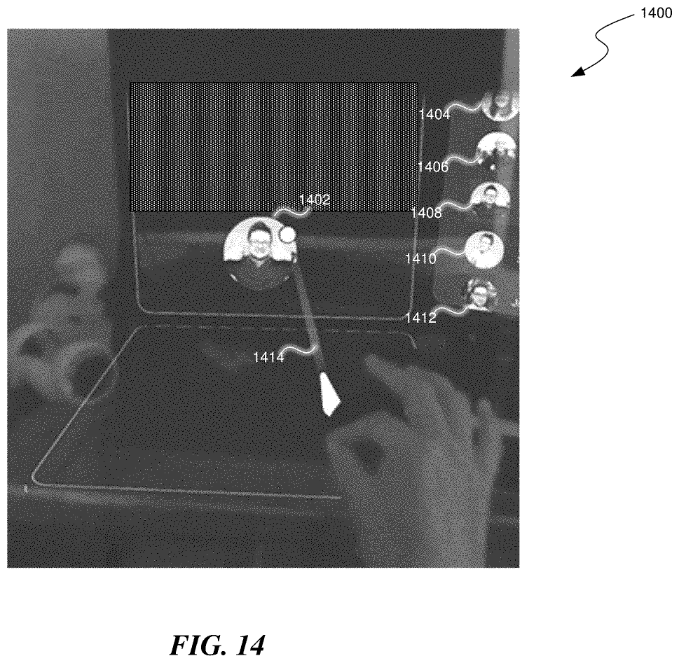

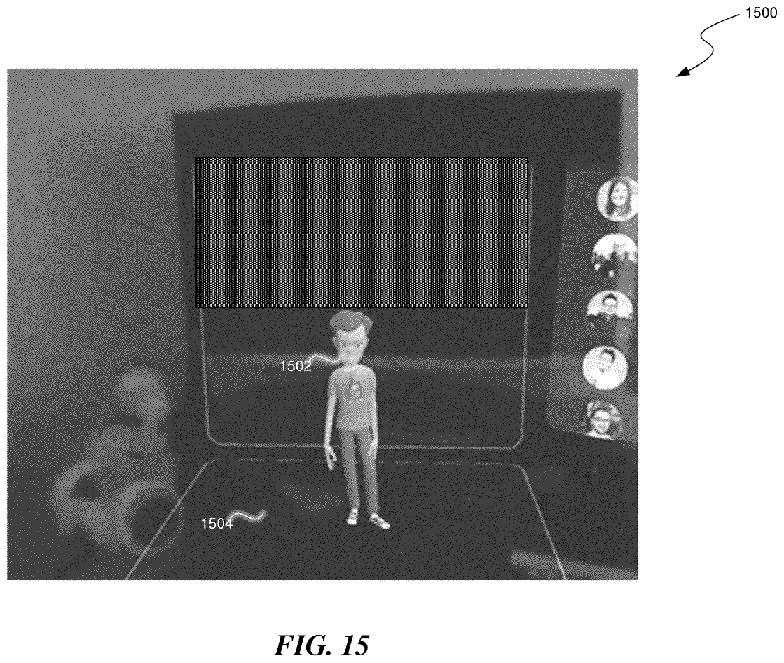

FIGS. 14 and 15 illustrate examples 1400 and 1500 of peeling a person object out of a list as a glint and dropping the glint onto a flat surface as a contextual breakpoint for transitioning to an avatar version of the person object. In example 1400, a list of person objects 1404-1412 has been displayed in an artificial reality environment. A user has directed a ray 1414 at the person object 1408 and dragged it out of the list, creating person object 1402, which is displayed in a glint view due to it presently being manipulated by the user. Continuing to example 1500, the user has dropped the glint view of the person object 1402 onto the flat, horizontal surface 1504. This caused the person object to transition to an avatar view 1502, standing on the surface 1504.

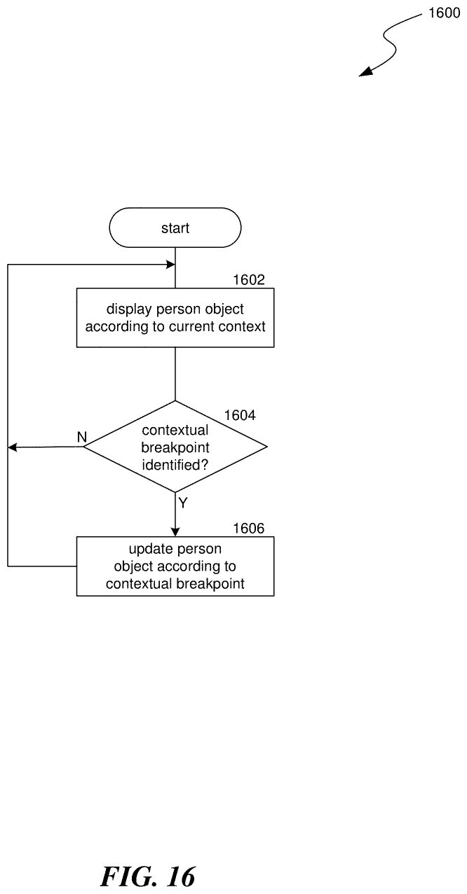

FIG. 16 is a flow diagram illustrating a process 1600 used in some implementations for switching between versions of person virtual objects in response to contextual breakpoints. In some implementations, process 1600 can be performed on an artificial reality device, e.g., by a sub-process of the operating system, by an environment control “shell” system, or by an executed application in control of displaying one or more person objects in an artificial reality environment.

At block 1602, process 1600 can display a person object according to a current context. When an application creates a person object to be represented in an artificial reality environment, process 1600 can display the person object as a glint, an avatar, or a portrait, depending on the context of how the person object is to be used. For example, process 1600 can show a glint view of the person object where the person object is to be created in a hand of the user (e.g., the person object is being peeled out of another object, generated in response to a gesture, etc.), is part of a list of people objects, is embedded with limited space in another object, etc. As another example, process 1600 can show an avatar view of the person object where the person object is to be placed on a flat surface with sufficient space to show the avatar person object. As yet another example, process 1600 can show a portrait view of the person object where the person object is to be placed on a wall or other vertical surface with sufficient space to show the portrait person object.

In some implementations, process 1600 can adjust the person object to have greater or lesser fidelity to the real-world appearance of the represented user based on the permissions of the viewing user. For example, various levels of fidelity from a generic silhouette or other default image, to a fanciful avatar, to an avatar with features similar to the represented user, to a still image or pre-recorded video of the represented user, to a live feed of the represented user, can be shown according to the highest level of permissions of the viewing user.

At block 1604, process 1600 can determine whether a contextual breakpoint has occurred for switching the person object to a different view, or the view itself might adapt to suit the context. Such a contextual breakpoint can include a transition between two of the contexts described in relation to block 1602. For example, if a user picks up a person object in an avatar view, process 1600 can identify a contextual breakpoint for transitioning to a “held” view, such as an icon, a floating head, or a glint view. As another example, if a user drops a person object on a surface, process 1600 can identify a contextual breakpoint for transitioning to a portrait or portal view if the surface is vertical and a standing photo or a 3D standing avatar view if the surface is horizontal. If process 1600 identifies such a contextual breakpoint, process 1600 can continue to block 1606 where it can transition display of the person object according to the identified contextual breakpoint. If process 1600 does not identify such a contextual breakpoint or following block 1606, process 1600 can return to block 1602 where it continues to display the person object according to the current context.

A XR mouse extension system can recognize mouse contextual switches, and in response activate and deactivate PC mouse input and a virtual cursor used in the artificial reality environment. Further, upon activating the virtual cursor, the XR mouse extension system can identify a user intended subject, such as an artificial reality environment area, a real-world surface, or a virtual object, such that the virtual cursor provides input in relation to the subject.

When in use, the XR mouse extension system can identify a PC-to-XR mouse context switch, such as moving the mouse to or beyond the edge of a PC display, activating a detach mouse UI control, speaking a detach mouse command, making a specified gesture, interacting or focusing on an area outside the PC for a threshold amount of time, etc. Upon recognizing this mouse context switch, the XR mouse extension system can prevent the PC from acting on mouse input. For example, the XR mouse extension system can include or communicate with a companion application executing on the PC, which can control whether the PC reacts to mouse movement, clicks, scrolls, or other mouse inputs. Upon recognizing the PC-to-XR mouse context switch, the XR mouse extension system, via this companion application, can disable the mouse input to the PC. Further in response to the PC-to-XR mouse context switch, the XR mouse extension system can create a virtual cursor in the artificial reality environment. Such a cursor virtual object can be a world-locked 2D or 3D virtual object.

In some cases, the XR mouse extension system can identify a user-intended subject upon the mouse context switch and can create the virtual mouse in relation to (e.g., placed on and/or providing input for) the subject. In some cases, the user-intended subject can be determined based on a determination of where the user is looking, a location and/or velocity on the PC screen where the mouse was when the mouse context switch occurred, a current or recently active object or area in the artificial reality environment, and/or which objects in the artificial reality environment are defined for mouse input. In some cases, the virtual cursor can be restricted to providing input for the subject. For example, if the subject is a menu virtual object, movements of the virtual cursor can be interpreted to keep the virtual cursor inside the bound of the menu virtual object. In some cases, the subject can change, e.g., upon detecting a new user intended subject. When the XR mouse extension system detects an XR-to-PC mouse context switch, the XR mouse extension system can disable the virtual cursor and cause the PC to resume (via the companion application) accepting mouse inputs.

In a first example, a user of a VR device may be in an artificial reality environment providing a virtual reality conference with her co-workers in which a version of her PC screen is streamed into the artificial reality environment, allowing her to continue using her PC while in the virtual reality conference. A “detach mouse” virtual object control may be displayed in the artificial reality environment, as an overlay on her streamed PC. When the user moves her mouse to that control and clicks it, her mouse detaches from the stream of her PC and automatically goes to a shared work area, in this example, a whiteboard shared with her co-workers. The mouse is color-coded and/or labeled with the user's handle so other users in the virtual reality conference can identify who each of the virtual mice that may be in the shared whiteboard belong to. The user can make indications and interact with objects on the virtual whiteboard until she drags the virtual cursor off the whiteboard, at which point it snaps back onto the stream of her PC, allowing her to once again use her real-world mouse as an input to her PC as shown in the stream of her PC's display.

In another example, a user of an MR device may be in an artificial reality environment providing virtual objects as overlays onto her view of the real word, including a PC which she can see. The user can speak a “detach mouse” command or click a mouse button mapped to this command, to cause her artificial reality device to send a command to a companion application on the PC, hiding the mouse and stopping its input from being recognized by the PC. The artificial reality device can be tracking where the user is looking, and the XR mouse extension system can create a virtual cursor on a virtual object that is the location of the user's gaze focus. The user can interact with the virtual object through movements, clicks, scrolls etc. of her real-world mouse. The user can speak an “attach mouse” command or click the mouse button mapped to this command, to cause the XR mouse extension system to hide and disable the virtual cursor and send a command to the companion application to have the PC resume accepting input from the real-world mouse.

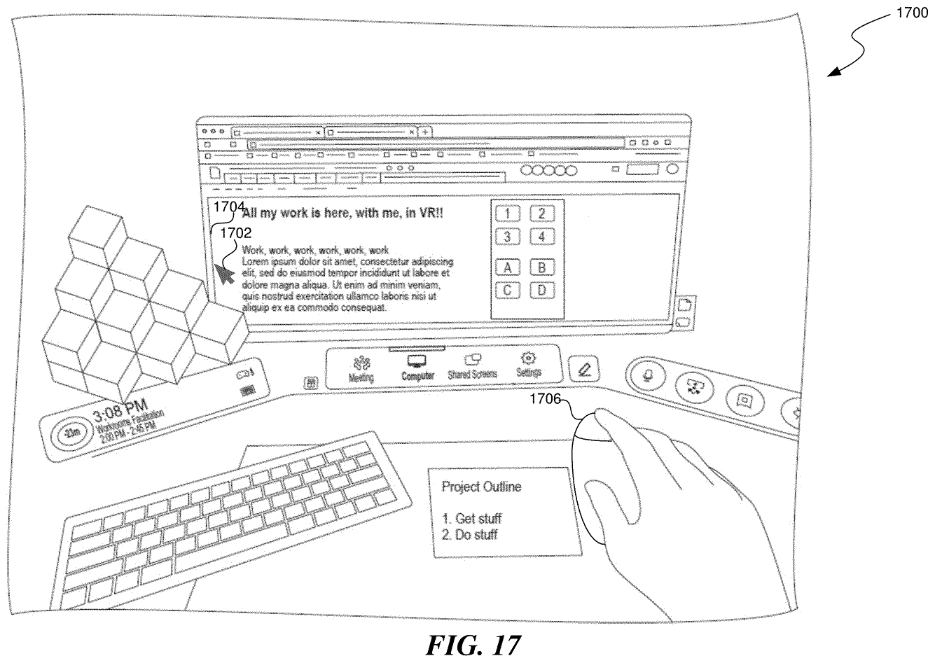

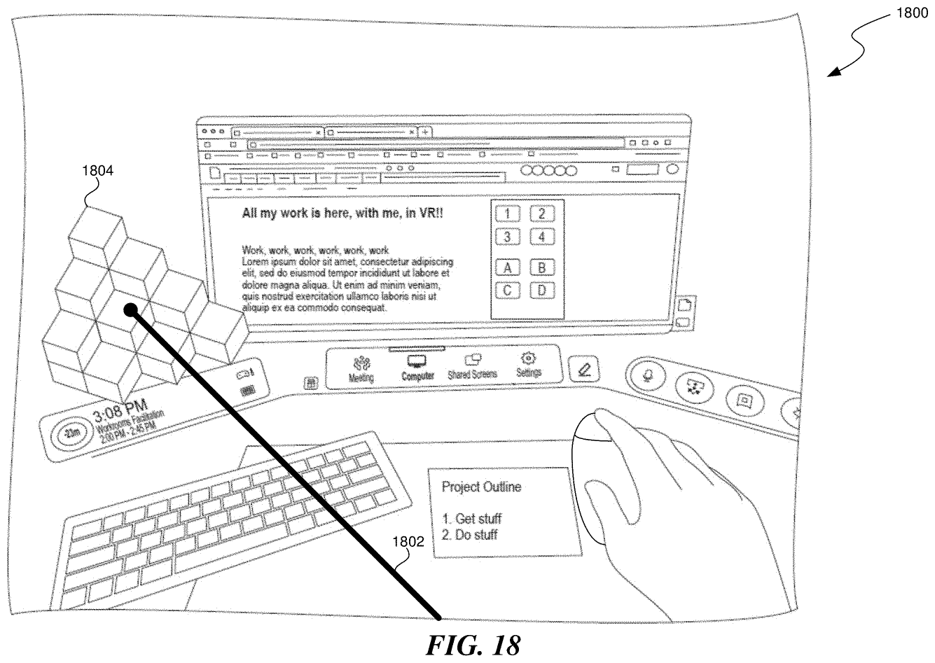

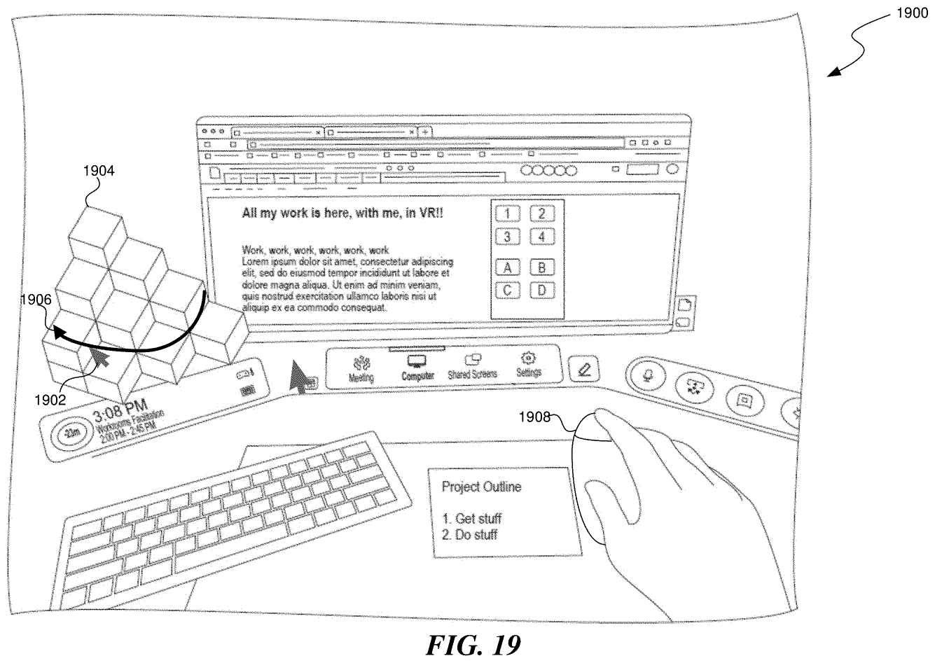

FIG. 17 is an example 1700 of a screen-edge PC-to-XR mouse context switch. In example 1700, a user has, by manipulating mouse 1706, moved the mouse 1702 to the edge 1704 of a stream of her PC appearing in a virtual reality artificial reality environment. The XR mouse extension system interprets this movement as a command to detach the mouse from the PC and create a virtual cursor in the artificial reality environment. FIG. 18 is an example 1800 of determining a subject for the creation of a virtual cursor based on a determined user gaze 1802. In example 1800, the direction of a user's gaze 1802 is tracked by an artificial reality device. Upon a PC-to-XR mouse context switch, the XR mouse extension system uses the tracked user gaze 1802 to identify a current subject of the user's attention, which in example 1800 is object 1804. FIG. 19 is an example 1900 of a virtual cursor 1902 created on an object 1902 specified by a gaze focus. In example 1900, the virtual cursor 1902 has been created to interpret inputs to mouse 1908 as manipulations for subject object 1904. Further in example 1900, these mouse movements are interpreted as X axis rotations of object 1904, as indicated by arrow 1906, while these mouse movements are blocked, by a companion application, from providing input to the PC.

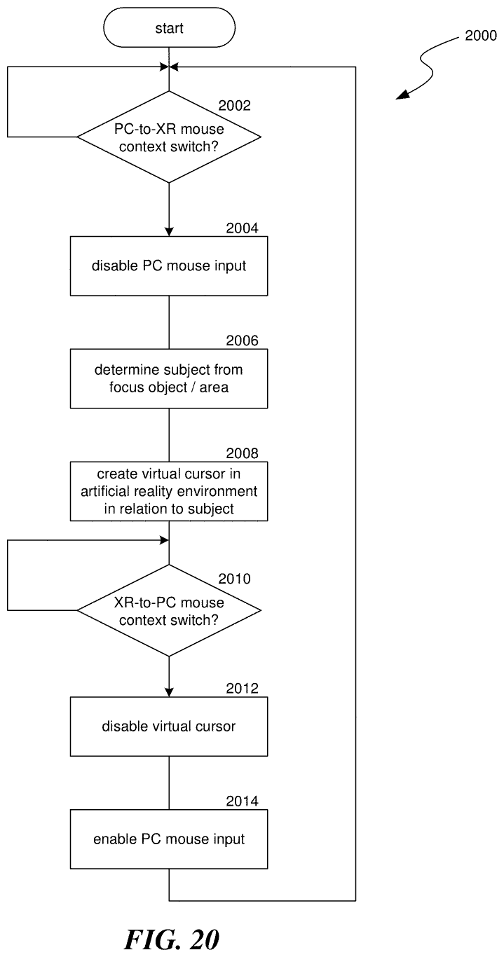

FIG. 20 is a flow diagram illustrating a process 2000 used in some implementations for extending a mouse for artificial reality environment input. In various implementations, process 2000 can be performed on an artificial reality device, on a PC, or partially on both the artificial reality device and PC. Process 2000 can be initiated as part of an operating system, control application (e.g., shell), or standalone application on the artificial reality device or as a process of an artificial reality device companion application executed by the PC (e.g., started at PC startup or through a user command).

At block 2002, process 2000 can determine whether there has been a PC-to-XR mouse context switch. In various implementations, detecting the PC-to-XR mouse context switch can include one or more of: determining (via a communication from a companion application on the PC) that a user pressed a mouse button remapped to this context switch or provided a keyboard shortcut mapped to this context switch; determining that the user activated a UI control provided by the artificial reality device (e.g., a virtual button or other virtual object); determining that the user activated a button or other physical control of the artificial reality device mapped to this context switch; determining (e.g., via the companion application or via a visual interpretation of a PC display output) that the user moved the mouse to or beyond an edge of the PC display screen; determining that the user has looked off-screen for threshold period of time; or recognizing a voice command or gesture mapped to this context switch.

At block 2004, process 2000 can disable PC mouse input (e.g., movement, button presses/drags, scroll wheel inputs, track pad movements, etc.) In some implementations, process 2000 accomplishes this by signaling to the companion application on the PC, e.g., via a communication channel established between the PC and artificial reality device. The companion application can either intercept the mouse input or can communicate with the PC operating system to prevent the mouse input from being passed to other applications. In some implementations, disabling the PC mouse input can also include hiding the mouse from the displayed PC screen whether that's from a stream of the PC screen into a VR artificial reality environment or removing the mouse from a real world display viewable by a user of an MR device.

At block 2006, process 2000 can determine a subject in the artificial reality environment based on a focus object or area. In various implementations, process 2000 can determine the subject by one or more of: determining where the user's gaze is directed, selecting an active input area (e.g., a menu, working panel, 3D model or other real or virtual object with which user is or has most recently interacted), determining a location and/or velocity on the PC screen where the mouse was when the context switch occurred (e.g., creating a smooth transition to have a virtual cursor appear where the user moved the mouse off the screen and/or interpreting where likely user was dragging her mouse to, based on the direction and velocity of the mouse movement toward the screen edge), etc. In some cases, the artificial reality device may be pre-configured to identify certain real or virtual objects or object types (e.g., menus, flat panels, 3D models) as accepting mouse inputs, and potential subjects may be limited to these objects or object types. In some cases, a subject can be an area of the artificial reality environment, e.g., a threshold volume around where the user was focused when the virtual cursor was created.

At block 2008, process 2000 can create a virtual cursor in the artificial reality environment in relation to the subject. In various implementations, the virtual cursor may be crated spatially on, or in relation to, (from the user's point of view) the subject. The virtual cursor can be configured to resemble the cursor used by the PC (e.g., as a 2D or 3D model) or as another cursor used in 3D space. The virtual cursor can be world locked, such that as the artificial reality device is moved by the user, the virtual cursor appears to remain in the same location.

In some implementations, the virtual cursor can be controlled based on inputs identified by the mouse, sent to the PC, and then transmitted to the artificial reality device, e.g., via a communications channel established between the companion application and the artificial reality device. In other implementations, the inputs to the mouse can be determined by capturing images or other sensor data recording mouse position and interactions and interpreting them without communications from the mouse. In some cases, the virtual cursor may be limited to interaction in relation to the subject. For example, if the subject is an object, the virtual cursor may be limited to interact with the object. In some implementations, the virtual cursor can be controlled on a flat virtual object subject by moving the virtual cursor according to the 2D movements of the real-world mouse. When the subject is a 3D object or volume, a predefined mapping of mouse input combinations to 3D interactions can be used to set virtual cursor inputs. For example, a drag mouse movement can be mapped to a rotation of the target 3D object, a double-click and drag mouse movement can be mapped to movements of the 3D object in an X-Y plane (from user's point of view), a scroll-wheel mouse input can be mapped as movement of the 3D object in the Z direction, etc. In some implementations, a subject can be updated, and thus where the virtual cursor is and/or how its inputs are constrained, can be updated accordingly. For example, if a user's gaze switches to another object or area for a threshold amount of time or the user moves the virtual cursor to or beyond the edge of the current subject, the subject can be updated as discussed above in relation to block 2006.

At block 2010, process 2000 can determine whether there has been an XR-to-PC mouse context switch. In various implementations, identifying an XR-to-PC mouse context switch can include identifying that the user pressed a mouse button or keyboard shortcut mapped to this context switch, activating a UI control mapped to this context switch, the subject object being closed, identifying that the user has looked at the PC screen for threshold amount of time, identifying a voice command or gesture mapped to this context switch, etc.

At block 2012, process 2000 can disable the virtual cursor. This can include hiding or deleting the virtual cursor and stopping interpreting mouse input as interactions with the artificial reality environment outside the PC.

At block 2014, process 2000 can enable mouse input to the PC. This can include reversing the process performed at bloc 2004, e.g., by signaling to the companion application on the PC to: show the mouse (e.g., where it was disabled or at a location relative to where the virtual cursor was shown); stop intercepting the mouse input; and/or stop preventing the mouse input from being passed to other applications. Following block 2014, process 2000 can return to block 2002 to again monitor for a PC-to-XR mouse context switch.

The disclosed technology can include, for example, a method for switching between versions of a person virtual object in response to contextual breakpoints, the method comprising: identifying a first artificial reality environment context; displaying the person virtual object in a first view corresponding to the first artificial reality environment context; identifying a second artificial reality environment context different from the first artificial reality environment context; and in response to identifying the second artificial reality environment context, displaying the person virtual object in a second view corresponding to the second artificial reality environment context.

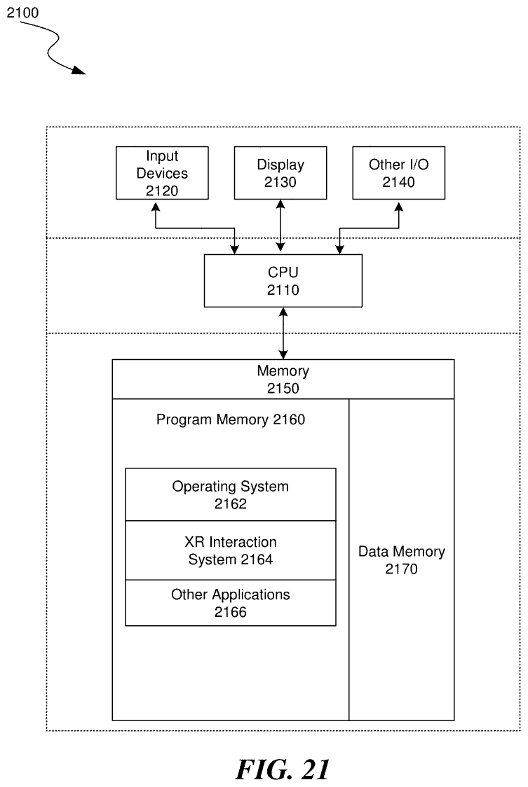

FIG. 21 is a block diagram illustrating an overview of devices on which some implementations of the disclosed technology can operate. The devices can comprise hardware components of a device 2100, which can include one or more input devices 2120 that provide input to the Processor(s) 2110 (e.g., CPU(s), GPU(s), HPU(s), etc.), notifying it of actions. The actions can be mediated by a hardware controller that interprets the signals received from the input device and communicates the information to the processors 2110 using a communication protocol. Input devices 2120 include, for example, a mouse, a keyboard, a touchscreen, an infrared sensor, a touchpad, a wearable input device, a camera- or image-based input device, a microphone, or other user input devices.

Processors 2110 can be a single processing unit or multiple processing units in a device or distributed across multiple devices. Processors 2110 can be coupled to other hardware devices, for example, with the use of a bus, such as a PCI bus or SCSI bus. The processors 2110 can communicate with a hardware controller for devices, such as for a display 2130. Display 2130 can be used to display text and graphics. In some implementations, display 2130 provides graphical and textual visual feedback to a user. In some implementations, display 2130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 2140 can also be coupled to the processor, such as a network card, video card, audio card, USB, firewire or other external device, camera, printer, speakers, CD-ROM drive, DVD drive, disk drive, or Blu-Ray device.

In some implementations, the device 2100 also includes a communication device capable of communicating wirelessly or wire-based with a network node. The communication device can communicate with another device or a server through a network using, for example, TCP/IP protocols. Device 2100 can utilize the communication device to distribute operations across multiple network devices.

The processors 2110 can have access to a memory 2150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 2150 can include program memory 2160 that stores programs and software, such as an operating system 2162, XR interaction system 2164, and other application programs 2166. Memory 2150 can also include data memory 2170, which can be provided to the program memory 2160 or any element of the device 2100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

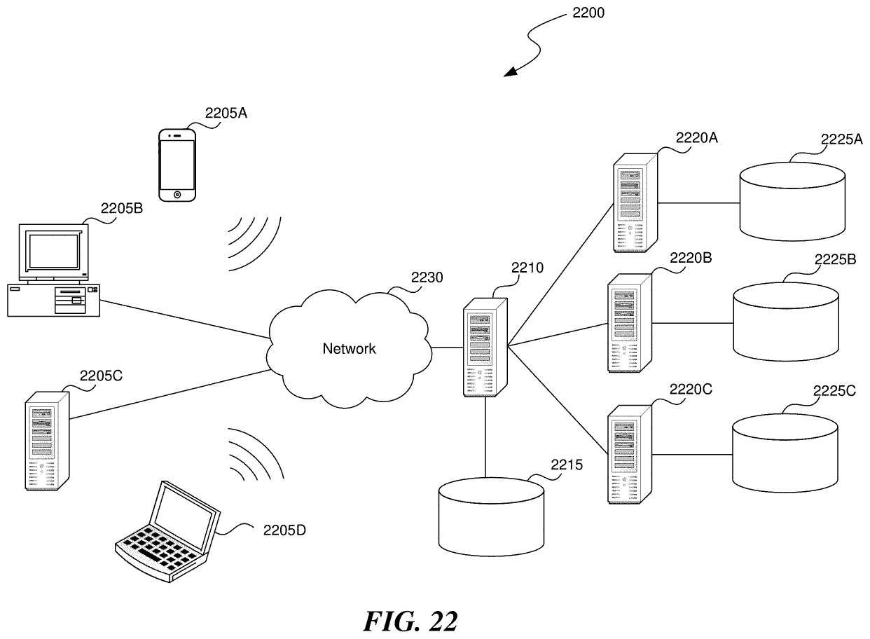

FIG. 22 is a block diagram illustrating an overview of an environment 2200 in which some implementations of the disclosed technology can operate. Environment 2200 can include one or more client computing devices 2205A-D, examples of which can include device 2100. Client computing devices 2205 can operate in a networked environment using logical connections through network 2230 to one or more remote computers, such as a server computing device.

In some implementations, server 2210 can be an edge server which receives client requests and coordinates fulfillment of those requests through other servers, such as servers 2220A-C. Server computing devices 2210 and 2220 can comprise computing systems, such as device 2100. Though each server computing device 2210 and 2220 is displayed logically as a single server, server computing devices can each be a distributed computing environment encompassing multiple computing devices located at the same or at geographically disparate physical locations. In some implementations, each server 2220 corresponds to a group of servers.

Client computing devices 2205 and server computing devices 2210 and 2220 can each act as a server or client to other server/client devices. Server 2210 can connect to a database 2215. Servers 2220A-C can each connect to a corresponding database 2225A-C. As discussed above, each server 2220 can correspond to a group of servers, and each of these servers can share a database or can have their own database. Databases 2215 and 2225 can warehouse (e.g., store) information. Though databases 2215 and 2225 are displayed logically as single units, databases 2215 and 2225 can each be a distributed computing environment encompassing multiple computing devices, can be located within their corresponding server, or can be located at the same or at geographically disparate physical locations.

Network 2230 can be a local area network (LAN) or a wide area network (WAN), but can also be other wired or wireless networks. Network 2230 may be the Internet or some other public or private network. Client computing devices 2205 can be connected to network 2230 through a network interface, such as by wired or wireless communication. While the connections between server 2210 and servers 2220 are shown as separate connections, these connections can be any kind of local, wide area, wired, or wireless network, including network 2230 or a separate public or private network.

In some implementations, servers 2210 and 2220 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for presenting a virtual space in at least two of at least four, spatially configured modes, the method comprising:
presenting the virtual space to a first user in a first mode; and
presenting the virtual space to a second user, different from the first user, in a second mode different from the first mode;
wherein the first mode and the second mode are each one of the at least four, spatially configured modes including:
an audio only mode providing spatial audio based on the virtual space;
a 2D mode providing a third-person view into the virtual space;
a video calling mode providing a video feed of the virtual space; and
a 3D-rooms mode providing an artificial reality environment of the virtual space.

2. A method for triggering, from an artificial reality (XR) device, an action on a personal computing device, the method comprising:
identifying, on the XR device, a trigger mapped to personal computing device action;
connecting to an action service running on the personal computing device; and
providing a command to the action service to perform the personal computing device action mapped to the identified trigger.

3. A method for extending a mouse for artificial reality environment input, the method comprising:
identifying a PC-to-XR mouse context switch;
in response to the PC-to-XR mouse context switch:
disabling PC mouse input;
determining an artificial reality environment subject from a focus object or area; and
creating a virtual cursor in the artificial reality environment in relation to the artificial reality environment subject.

4. The method of claim 3 further comprising:
identifying a XR-to-PC mouse context switch; and
in response to the XR-to-PC mouse context switch:
disabling the virtual cursor; and
enabling PC mouse input.
